(19) United States
(12) Patent Application Publication
(10) Pub. No.: US 2009/0282100 A1
(43) Pub. Date: Nov. 12, 2009

(54) METHOD FOR SYNDICATING BLOGS AND COMMUNITIES ACROSS THE WEB

(76) Inventors: Sang J. Kim, Morristown, NJ (US); Malcolm A. Smith, Madison, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/464,233

(22) Filed: May 12, 2009

Related U.S. Application Data
(60) Provisional application No. 61/052,436, filed on May 12, 2008.

(51) Int. Cl. G06F 15/16; G06F 21/20

(52) U.S. Cl. 709/203; 709/206; 726/11

(57) ABSTRACT

A method for syndicating groups from one web site to one or more additional web sites over a distributed network is disclosed. A group is created at the first web site. The group is published to make the group available for syndication. The group is presented as potentially acceptable for syndication at a second web site. A selection is received that the group is acceptable. The group is associated with the second web site in a database. A request is made to the database by the second web site to determine if there is any acceptable group content to be rendered on the second web site. Acceptable content associated with the group is transmitted to the second web site. The acceptable content is rendered at the second web site.

### CROSS-REFERENCE TO RELATED APPLICATIONS

This application claims the benefit of U.S. provisional patent application No. 61/052,436 filed May 12, 2008, the disclosure of which is incorporated herein by reference in its entirety.

### FIELD OF THE INVENTION

The present invention relates generally to social media, and more particularly, to a method for syndicating blogs and social communities over a distributed network.

### BACKGROUND OF THE INVENTION

Since the advent of the Internet, the Web has evolved from primarily an electronic publishing system in which companies publish information to Web sites for passive consumption by users, to one in which users actively connect to and communicate with each other. Most user-to-user communication via the Internet has been dominated by email, instant messaging, bulletin boards, and blogs. Email has become a more formal form of communication and is better suited for one-on-one communication or for information distribution to a group. Email is poorly suited for group discussions. With bulletin boards, newsgroups, and blogs, messages are posted to a common location for anyone from a selected group to read, and then readers can post messages back. Bulletin boards better support groups but are designed to be organized by topics, not groups of people. Instant messaging is like email but messages are sent in real time. Blogs are designed for a one-to-many publishing.

These traditional tools are ill-suited for group communications on the Internet. People belong to have family, school friends, clubs, or neighborhoods. They need tools that enable them to communicate, coordinate, and share information and media amongst people in a group. Moreover, people would greatly benefit if they could access the knowledge of their extended groups, i.e., the groups that the members of their groups belong to and so on. None of the above methods of communicating over the Internet support distributed network communication among extended groups of people.

With the evolution of the Internet and World-Wide Web (herein commonly referred to as Web 2.0), web logs (blogs), online communities, social networking web sites and micro-sites have emerged to allow people to gather and communicate virtually around topics, lifestyles, issues, etc. The publishers of Web 2.0 web sites use these vehicles to create engaging conversations that generate revenue by triggering web-based advertising. The business strategy employed by Web 2.0 creators is to drive traffic to community web sites or a community portion of a web site via online marketing, which may include search engine advertising, web site online advertisements, search engine optimization techniques, email marketing, etc. In all cases, the primary result of employing these techniques is to motivate users to visit the targeted web sites, view its content, and thereby trigger its revenue generating advertising content.

The strategy of driving users to visit a community web site or a community portion of a web site suffers from several problems for both the publishers of these web sites and for the users of these web sites. For publishers, it is expensive to conduct online marketing in order to bring users to the target web site. It is also difficult to generate a critical mass of like-minded users culled from the potential audience of a web site. Further, community sites typically require user registration that many users are reluctant to provide.

For users, web sites having diverse topics and communities catering to non-overlapping topics create a fragmented environment that forces people to go to many sites to satisfy their various interests. The user may be discouraged by the cacophony of competing voices for their advertising dollar. Distinct from the annoyance factor for a user having to deal with the multiplicity of on-line advertisements is the additional burden of having to deal with registration requirements. The user may be faced with having to remember many user names, passwords and profiles without a common method to manage them.

For marketers, having a branded micro-site within each publisher's web site requires creating a custom set of web pages and designs for each site. This makes creating a broad campaign time-consuming, expensive and difficult to execute, and difficult to manage and measure success.

One way to overcome fragmentation related coordinating a plurality of web sites is to have portions of several sites appear in a single web site accessible by one or more users of a community. One method known in the art for combining information from several sites into one site is the syndication of blogs. One method of syndicating blogs as is known in the art is “Really Simple Syndication” or an RSS feed. RSS is a content delivery vehicle. It is the format used when for syndicating news and other web content. Content that is distributed is called a feed. An RSS can be thought of as a personal wire service. RSS is a form of syndication in which one party creates the content and it is published in many places. The benefit of syndication is that a publisher or marketer gains access to a much wider audience for content or advertisements. RSS can be used for content on a web site or blog such as propagating recent changes on a page of a web site tech support updates, product news, and announcements.

One major problem with RSS feeds is their one way nature. To allow for a response to an RSS advertisement or announcement, a publisher at best may provide a static URL link to direct a user to the advertiser or publisher's web site. This requires the user to leave their web site.

Accordingly, what would be desirable, but has not yet been provided, is a computer-implemented method of syndicating blogs, news, and shared community information in a multi-way manner from within a user's own web-site without having to leave the user's web site.

### SUMMARY OF THE INVENTION

The above-described problems are addressed and a technical solution achieved in the art by providing a method and resulting apparatus for syndicating a group from a first web site to one or more additional web sites over a distributed network, comprising the steps of: creating a group at the first web site; publishing the group to make the group available for syndication; presenting the group as potentially acceptable for syndication at the second web site; receiving a selection that the group is acceptable, associating the group with the second web site in a database; making a request to the database by the second web site to determine if there is any acceptable group content to be rendered on the second web site; transmitting the acceptable content associated with the group to the second web site, and rendering the acceptable content at the second web site.

According to an embodiment of the present invention, the method may further comprise the step of syndicating the group to a third web site, wherein the acceptable content is visible in the first, second, and third web sites When a message is sent to the first group, the message may be readable in the first, second, and third web sites. A user may send a reply to the group, wherein the reply is readable in the first, second, and third web sites.

The first web site and the second web site may view identical news feeds.

According to an embodiment of the present invention, acceptable content may be at least one of a blog, news, shared community information news, a discussion forum, and a micro site. The method may further comprise the step of setting, permissions of the group to allow syndication to other web sites.

According to an embodiment of the present invention, a group may be one of a private group and a public group. When the group is a private group, a first user is permitted to join the group via an invitation from a second user of the group. The invitation may be in the form of an email with a link to a registration page.

According to an embodiment of the present invention, the method may further comprise the steps of: receiving a first message from a member of the group comprising a document, the first message also comprising an indication of whether the document is send-able to other groups to which the first member belongs; sending a list of groups to the member of the group to which the member belongs if the indication indicates that the document is send-able to other groups; receiving a message which indicates that the document is to be sent to a second group; associating the document with the second group; and sending the message to the group and the second group.

The document is viewable in in the group and the second group at both the first web site and the second web site. The document may be one of a text message, a file, and a formatted attachment. The document may be one of an email-like message, a calendar event, a trading message item, a digital photograph, a digital video attachment, and a digital audio attachment.

According to an embodiment of the present invention, the group is one of a private group and a public group.

According to an embodiment of the present invention, the apparatus may comprise a web-server: for receiving an indication that a group has been created at the first web site; for publishing the group to make the group available for syndication; for presenting the group as potentially acceptable for syndication at the second web site; for receiving a selection that the group is acceptable; making a request to determine if there is any acceptable group content to be rendered on the second web site; transmitting the acceptable content associated with the group to the second web site; and rendering the acceptable content at the second web site; and a database server: for associating the group with the second web site in a database.

According to an embodiment of the present invention, the web-server is further configured: for receiving a first message from a member of the group containing a document, the first message also containing an indication of whether the document is send-able to other groups; for sending a list of groups to the member of the group to which the first member belongs if the indication indicates that the document is send-able to other groups; for receiving a message which indicates that the document is to be sent to a second group; for associating the document with the second group; and for sending the message to the group and the second group.

The database server is further configured: for storing an association of the document with the second group; for storing an association of the second group with the document in the database; and for storing the document in a database.

The distributed network may be the Internet.

According to an embodiment of the present invention, the system may further comprise: an IP router for routing messages between the Internet and the web-server; a firewall for protecting said web-server from unwanted messages; and a notification server for querying the database server on a periodic basis to generate messages to send to users in order to report new activity or changes on the web site associated with the web-servers. The notification server may query the database for a list of new group invitations and sends email messages to each email address in the list.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 shows a block diagram of exemplary screens for a plurality of web sites (also called portals) that have been syndicated to each other, according to an embodiment of the present invention;

FIG. 2 is a block diagram depicting three web sites that illustrate syndication of groups between the web sites, according to an embodiment of the present invention;

FIG. 3 shows side-by-side web site screens for two different users of two different groups having syndicated groups in their web site screens;

FIG. 4 is an exemplary process flow diagram illustrating exemplary steps for syndicating a group (blogs and communities), according to an embodiment of the present invention;

FIG. 5 is a data entity relationship diagram depicting rules and relationships among groups, messages, etc., according to an embodiment of the present invention;

FIG. 6 is a block diagram illustrating a screen in a user's web site for creating a new group;

FIG. 7 is a process flow diagram illustrating exemplary steps for creating a new group, according to an embodiment of the present invention;

FIG. 8 is a block diagram illustrating a screen in a user's web site for publishing a new group, according to an embodiment of the present invention;

FIG. 9 is a process flow diagram illustrating exemplary steps for publishing the groups selected in FIG. 8, according to an embodiment of the present invention;

FIG. 10 is a block diagram illustrating a screen in a users web site for accepting groups published by other web site portals to be available on the user's web site;

FIG. 11 is a process flow diagram illustrating exemplary steps for a target web site portal to “accept” published groups as depicted in FIG. 10;

FIG. 12 is a block diagram of a news feed display, according to an embodiment of the present invention;

FIG. 13 is an exemplary process flow for presenting a news feed to a user, according to an embodiment of the present invention;

FIG. 14 is a block diagram of a syndicated group content module display, according to an embodiment of the present invention;

FIG. 15 is an exemplary process flow for presenting syndicated group content to a user, according to an embodiment of the present invention;

FIG. 16 is a block diagram showing the entities involved in the propagation of documents across groups, herein referred to as a “ripple,” according to an embodiment of the present invention;

FIG. 17 is a block diagram showing several “Rippling” scenarios, according to an embodiment of the present invention;

FIG. 18 depicts a block diagram of an official web site screen for joining one or more groups, according to an embodiment of the present invention;

FIG. 19 depicts an embodiment of a user screen for a user that is originating a message;

FIG. 20 is a process flow diagram illustrating exemplary steps for ‘Assigning Ripple Properties’ to a new message that a user creates for displaying to his current group or for rippling to other groups to which the user belongs, according to an embodiment of the present invention;

FIG. 21 depicts a user screen for a user that is receiving a message;

FIG. 22 depicts second screen that continues the user screen of FIG. 18, in the user is presented with check boxes listing all Groups to which the user belongs;

FIG. 23 is a process flow diagram illustrating exemplary steps for rippling a message to other groups, according to an embodiment of the present invention;

FIG. 24 is a process flow diagram illustrating exemplary steps for ‘Seeing’ or ‘Displaying Messages in a Group’, which include messages belonging to or rippled to a group as well as ‘seeing’ responses to previously posted messages, according to an embodiment of the present invention;

FIG. 25 is a process flow diagram illustrating exemplary steps for modifying the IsRipple-able property on an existing message;

FIG. 26 depicts a user screen for a user that is deleting a message;

FIG. 27 is a process flow diagram illustrating exemplary steps for deleting a messages in a group, according to an embodiment of the present invention; and

FIG. 28 is a block diagram of an exemplary system for syndicating a group and/or rippling documents over a distributed network, according to an embodiment of the present invention.

It is to be understood that the attached drawings are for purposes of illustrating the concepts of the invention and may not be to scale.

### DETAILED DESCRIPTION OF THE INVENTION

Certain embodiments of the present invention provide a computer-implemented method for syndicating blogs and Web-based communities by creating a set of related community elements that comprising web logs, online communities, discussion forums, online groups, micro sites that contain users and messages, ratings, replies (content) and syndicating all of the elements between Web site locations on distributed computer networks, which may include the Internet.

Embodiments of the present invention, hereinafter known as “Syndicated Communities,” allows community owners (including blogs, forums, groups, micro-sites) to syndicate an entire community from a host web site to a target web site that agrees to the syndication. Unlike other syndication mechanisms that exist today, syndicating is not implemented by a link or portion of the community that points back to the original community. The entire community is syndicated. In other words, the members, conversations and interactions occur in the syndicated web site itself. Syndicated Communities grow the community with each and every syndication, thereby effectively growing into one big community that exists across all syndicated sites.

A community owner can grow a community by simply syndicating to other web sites that desire the community. Communities can grow by leveraging the traffic and community members in the site that are syndicated to. The receivers of the syndicated communities benefit because they can offer specialized communities to their members that they could not have grown or created on their own. People stay in their main community and access more specialized communities without leaving their favorite community and without having to go through another registration process. Marketers can create brand communities and simply syndicate them to relevant sites without creating a new one for each site.

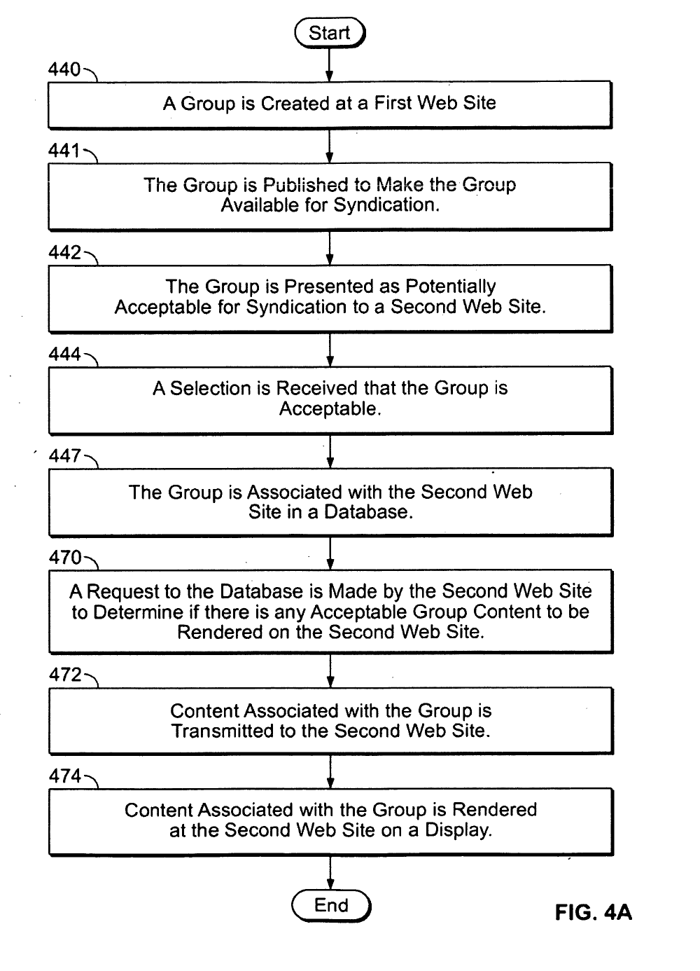

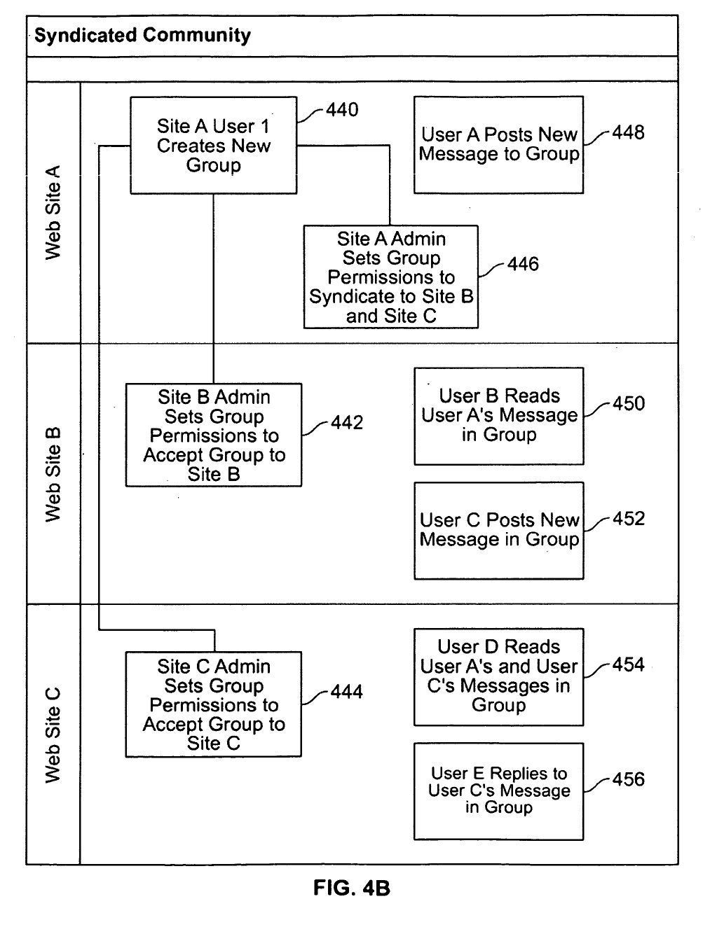

Communities (hereinafter referred to as groups) are created using a method outlined in FIG. 4 and described hereinafter. Web sites are selected to which the group is to be syndicated. Once syndicated, the group owner can simply post to their own group and have the post show up in all or some of the syndicated web sites. Members of any of the syndicated groups can see and join that syndicated groups from their own web site. Members of any of the syndicated groups can see new posts in their newsfeed from other groups. Once syndicated, the members of each web site are participating in the same group but from their own web sites. Regardless of which syndicated web site a user enters from, the user sees of the conversations (posts) across all of the syndicated web sites. These posts can be selectively shared with members and groups in their personal network.

As used herein, a “group” is a collection of users identified by a common group ID in a database. A group is a private group when users of the group provide the group ID to subsequent group members by invitation to the group. A group is a public group if its group ID is published in a publicly viewable list, thereby allowing any user to join the group.

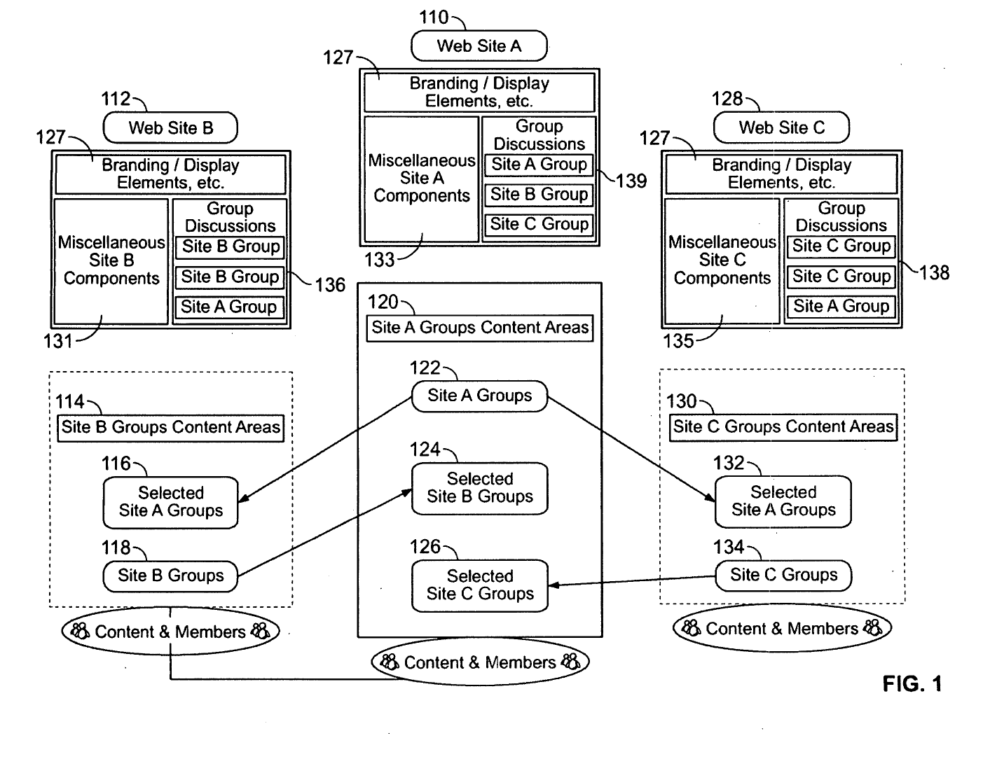

FIG. 1 shows a block diagram of exemplary screens for a plurality of web sites (also referred to herein as portals) that have been syndicated to each other, according to an embodiment of the present invention. FIG. 1 shows exemplary screen layouts of web site A 110, web site B 112, and web site C 128. Each of the web sites 110, 112, and 128 display a corresponding area 114, 120, 130 for content. The content may include one or more documents. As used herein, a document may refer to text, such as email-like messages, files, formatted attachments, calendar events, trading message items, digital photograph, digital video, digital audio, etc. The content is specific to a host group of the web sites 110, 112, 128 to which corresponding users belong. Each of the web sites 110, 112, 128 may list one or more groups 118, 122, 134 to which the user of each of the web sites 110, 112, 128 belongs. Exemplary embodiments of the present invention allow portions of the web sites 110, 112, 128 to display the groups and content of the groups 136, 139, 138 that have been syndicated.

For example, one or more groups 122 of web site A 110 may be syndicated to web site B 112 in area 116, and to web site C 128 in area 132. One or more groups 118 of web site B 112 may be syndicated to web site A 110 in area 124, and likewise one or more groups 134 of web site C 128 may be syndicated to web site A 110 in area 126. Although not shown in this example, any combination of syndication is permitted, which may include syndication of one or more of the groups 118 from web site B 112 to web site C 128, and syndication of one or more of the groups 134 from web site C 128 to web site A 110.

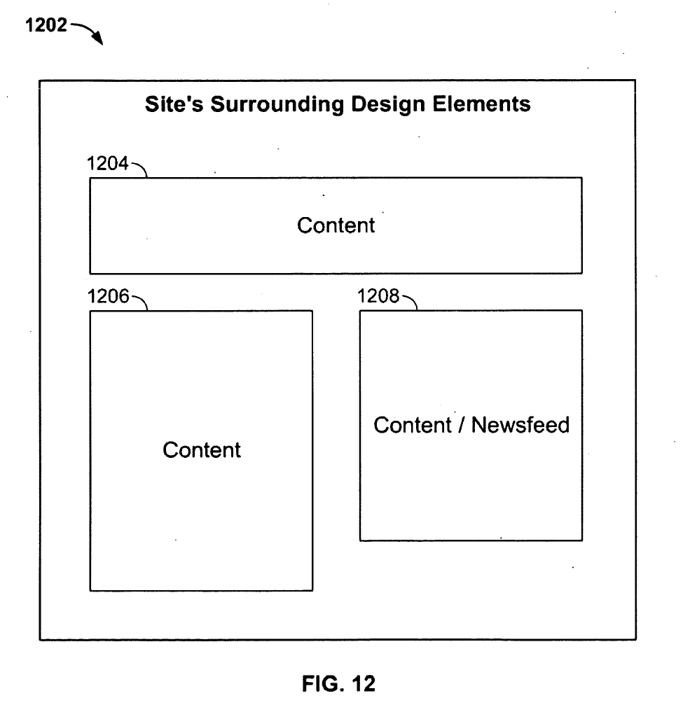

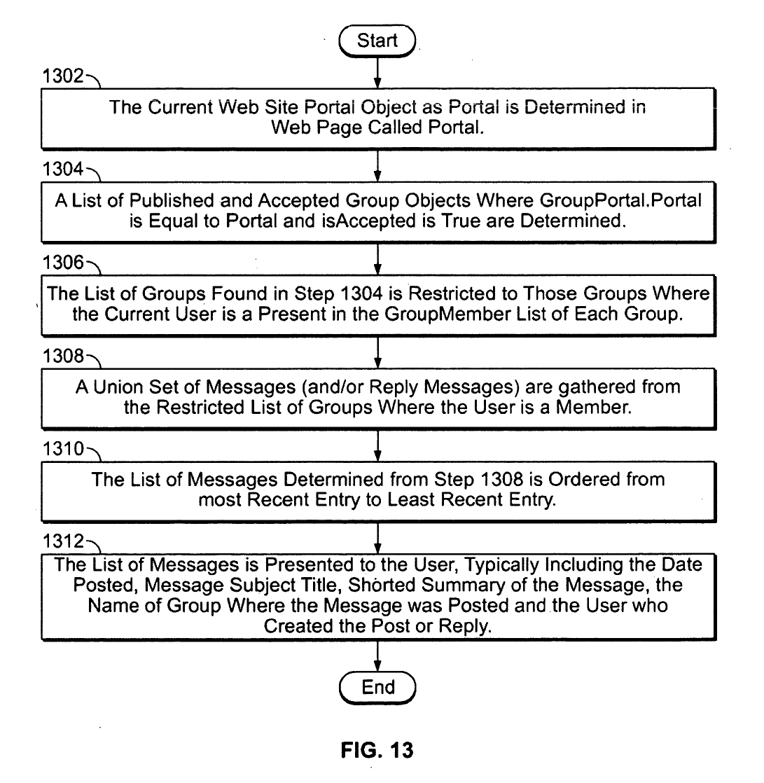

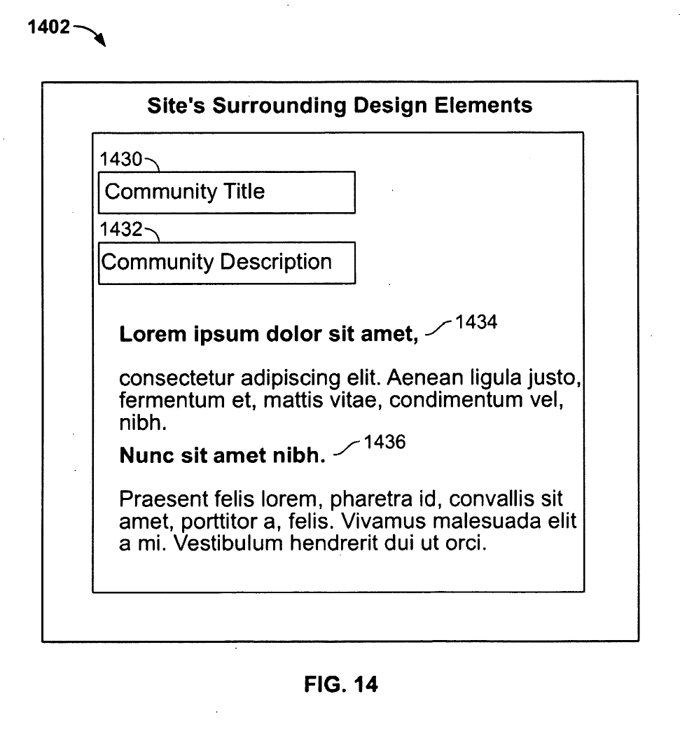

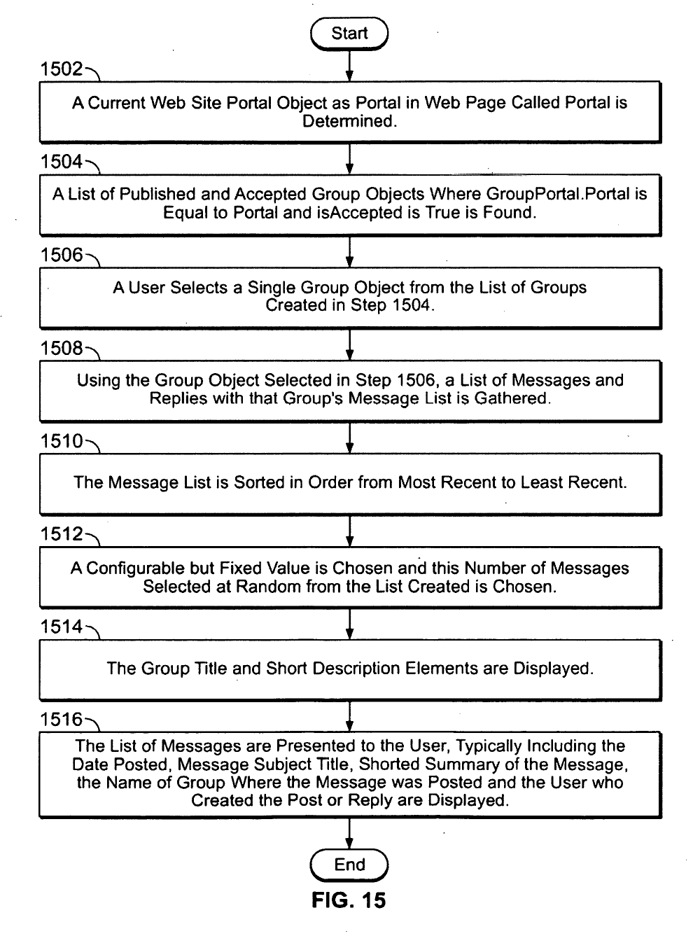

For the benefit of users of each web site, when new messages are posted in any group the user has joined, which may include include both normal groups and syndicated blogs and communities. A “newsfeed” module and a “syndicated group content module” are presented to the user when the user clicks on one of the groups in the links 136, 138, 139. The newsfeed module enables the user to quickly review new message items and view the details by clicking the item in the news feed. News feed are described in more detail in connection with FIGS. 12, 13. The syndicated group content module allows the user to view content in more detail. Syndicated group content modules and an exemplary process flow for displaying content from content modules are described hereinbelow in more detail in connection with FIGS. 14, 15.

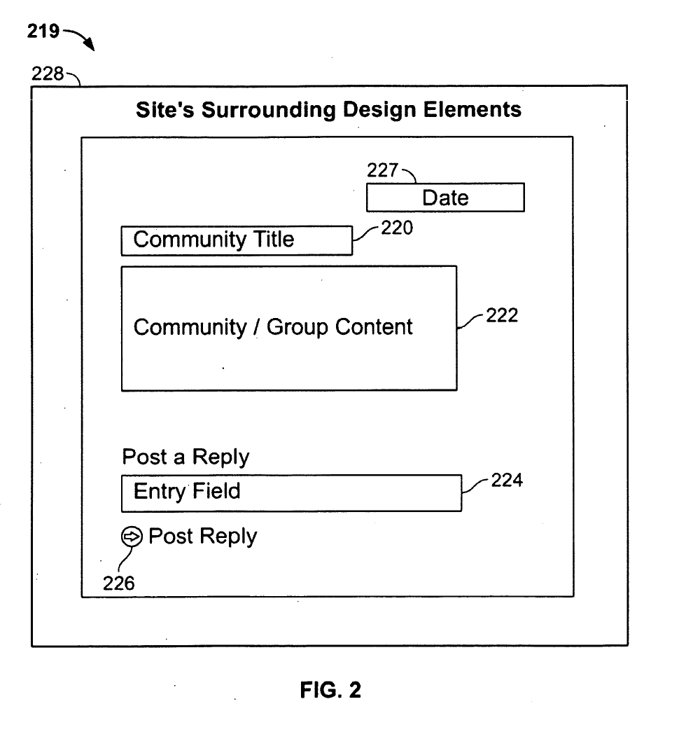

Portions of each of the web sites 112, 110, 128 respectively, may be reserved for links 136, 139, 138 to each of the groups syndicated to that web site for linking to syndicated group messages to be described hereinbelow in connection with FIG. 2. Referring now to FIG. 2, clicking on one of the links 136, 138, 139 of FIG. 1 enables the user to quickly review new message items and view details of the new message items belonging to any of either site A, B, or C's groups. The group screen 219 includes fields for the groups title 220, group content 222, and a reply field 224 and post reply button 226 for responding to the content 222. The group screen 219 may optionally include a date field 227. To provide the look and feel of the host web site, the group screen 219 may contain border content 228 that include surrounding design/display/branding elements of that web site. A typical screen for viewing content in more detail and a process flow for displaying the content are discussed below in connection with FIGS. 14 and 1S.

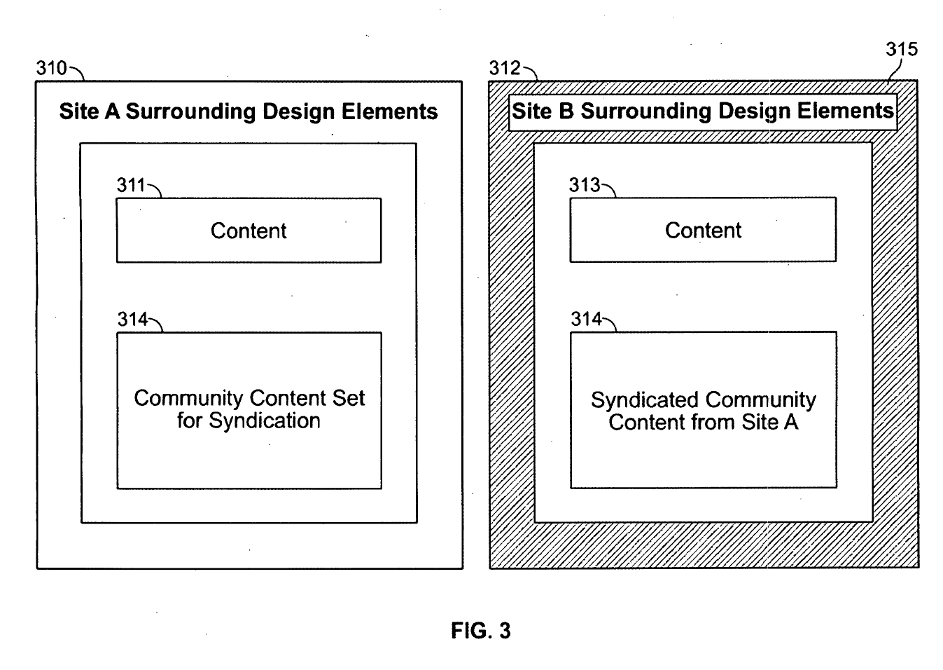

FIG. 3 shows side-by-side web site screens for two different users of two different groups. The screen for web site A 310 shows content 311 for the group associated with web site A, as well as content 314 that is set to be “syndicatable” in other web sites. The screen for web site B 312 shows content 313 for the group associated with web site B, as well as content 314 that was “syndicated” from web site A. Note that, although web site B shows the syndicated content 314 of web site A, web site B still has the surrounding design elements 315 that gives the look and feel of web site B.

Referring again to FIG. 1, border content 127 is also displayed in portions of web sites 112, 110, and 128. Each of the web sites 112, 110, 128 may also display miscellaneous components 131, 133, 135 pertaining only to that web site.

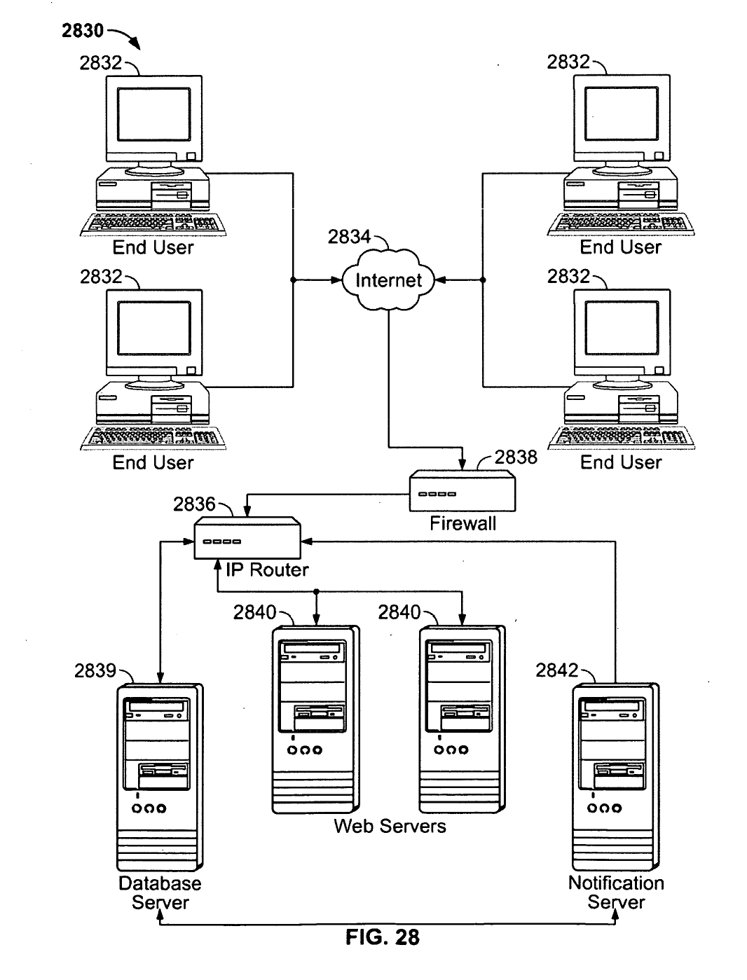

FIG. 4 is an exemplary process flow diagram illustrating exemplary steps for syndicating a group. It is assumed that a program is resident on each computer associated with a web site, and that messages can be passed to and from a common web server having a database to be described hereinbelow with reference to FIG. 28. At step 440, web site A creates a new group. At step 441, web site A publishes the group to make the group available to specific other web site portals. At step 446, the administrator of site A sets group A's permissions to allow syndication to other sites, in this case web sites B and C. At steps 442, potential acceptable groups are presented to the targeted web site, and at step 444, one or more of these groups may be accepted by targeted web sites to which to be syndicated (web sites B and C, respectively) such that published groups (e.g., from web site A) may be made available on the targeted web sites. At step 447, associations are made between the web site of the created group and the target web sites in a database. At step 470, web site B and C make request to the database to determine if there is any acceptable group content to be rendered on web site B and C. At step 472, acceptable content associated with the group A is transmitted to web site B and C. At step 474, web sites B and C receive acceptable content associated with group A to be displayed on web sites B and C's web pages (on a display). The syndication process is essentially one way, but, of course, web sites B and C can syndicate their groups so that web site A can view the content of the groups syndicated by web sites B and C.

Once the new group is syndicated, as an example, at step 448, User A in web site A may post a message to the Group. In web site B, at step 450, User B may read User A's message in the Group. At step 452, User C on web site B may post a new message in the Group. At web site C, at step 454, User D may read user A's and User C's messages in the Group. At step 456, User E in web site C may then reply to User C message in the Group.

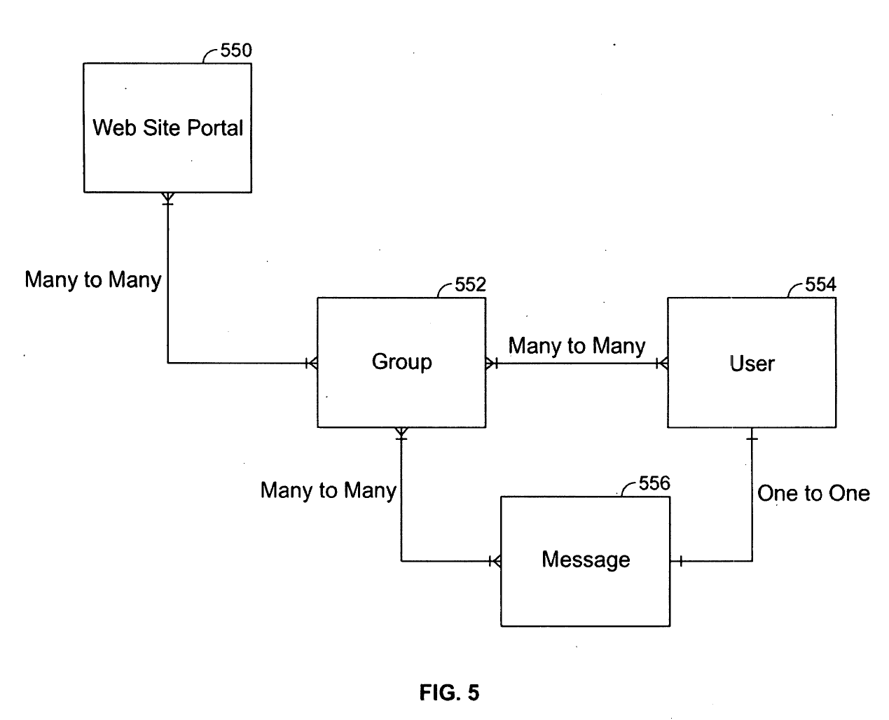

The rules and relationships among, groups, messages, etc., is shown in the data entity relationship diagram of FIG. 5. Users 554 may create one or more groups 552 within a web site 550. There may be one or more groups 552 in a web site 550. Each group 550 may be syndicated to one or more web sites 550. A group 552 may have one or more users 554. A group 552 may have one or more messages 556. A message 556 may appear in one or more groups 552. A message 556 is created/owned by a single user 554.

Syndicated groups may operate as either public or private groups. If a group is a private group, the private group is not listed in group collections of any web site, nor is the private group's content presented as syndicated group content. Current members of a private must invite new users to the private group after the group is published and accepted on the private users' web sites. The process of inviation will be described hereinbelow.

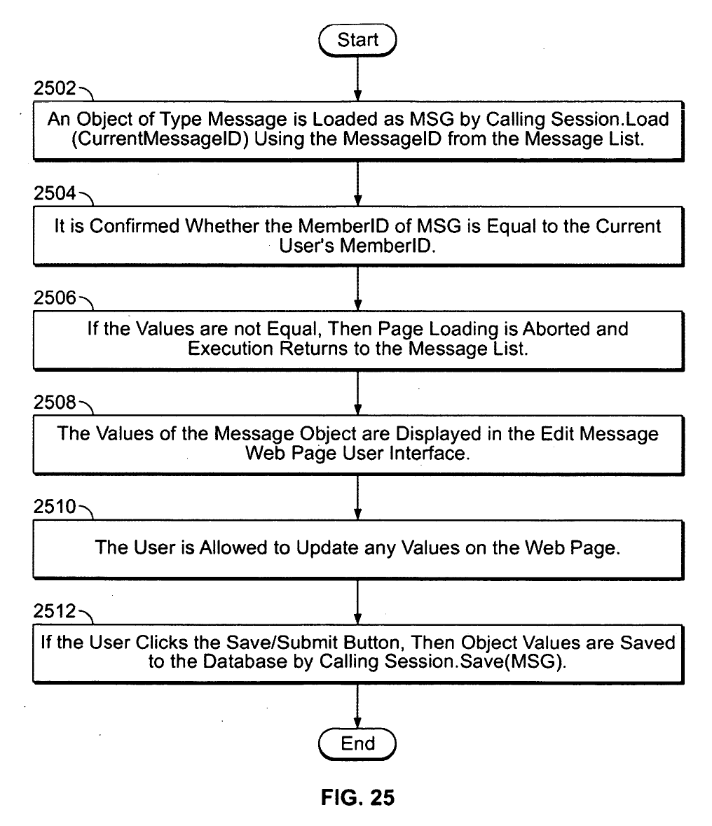

The data model stored in a database server involved in executing the steps of FIG. 4 on an exemplary system to be described hereinbelow in connection with FIG. 25 is listed below in Tables 1-7. Elements of Tables 1-7 will be referred to in subsequent discussions of the features of “Syndicated Communities.”

TABLE 1
User Member

| Column Name | Data Type |
|---|---|
| Memberid | Int |
| Username | Nvarchar |
| Lastname | Nvarchar |
| Firstname | Nvarchar |
| address1 | Nvarchar |
| address2 | Nvarchar |
| City | Nvarchar |
| Regioncode | Nchar |
| Countrycode | Nchar |
| Inactive | Bit |
| Creationdt | Datetime |
| Updatedt | Datetime |
| Emailaddress | Nvarchar |
| Messagealcode | Nvarchar |
| Referralcode | Nvarchar |
| *portalid | Int |

TABLE 2
Group

| Column Name | Data Type |
|---|---|
| Groupid | int |
| Groupname | nvarchar |
| Grouptypeid | Int |
| groupdescription | nvarchar |
| creationdt | Datetime |
| *portalid | Int |

TABLE 3
Group Member

| Column Name | Data Type |
|---|---|
| groupmemberid | Int |
| roletypeid | Nchar |
| emaildigesttype | Int |
| lastviewdate | Datetime |
| creationdt | Datetime |
| *groupid | Int |
| *memberid | Int |

TABLE 4
Message Document

| Column Name | Data Type |
|---|---|
| messageid | Int |
| memberid | Int |
| title | Nvarchar |
| messagebody | Ntext |
| imagepath | Nvarchar |
| thumbpath | Nvarchar |
| creationdt | Datetime |
| updatedt | Datetime |
| viewcount | Int |
| parentid | Int |
| location | Nvarchar |
| contact | Nvarchar |
| isripple-able | Bit |
| degreerule | Int |

TABLE 5
Group Message

| Column Name | Data Type |
|---|---|
| groupmessageid | int |
| memberid | Int |
| reftypeid | nchar |
| Srcgroupid | Int |
| Creationdt | datetime |
| *groupid | Int |
| *messageid | Int |

TABLE 6
Portal Group

| Column Name | Data Type |
|---|---|
| *groupid | Int |
| *portalid | Int |
| Islisted | Boolean |
| Issearchable | Boolean |
| Isaccepted | Boolean |

TABLE 7
Portal

| Column Name | Data Type |
|---|---|
| *portalid | Int |
| Name | Nvarchar |
| Rooturl | Nvarchar |

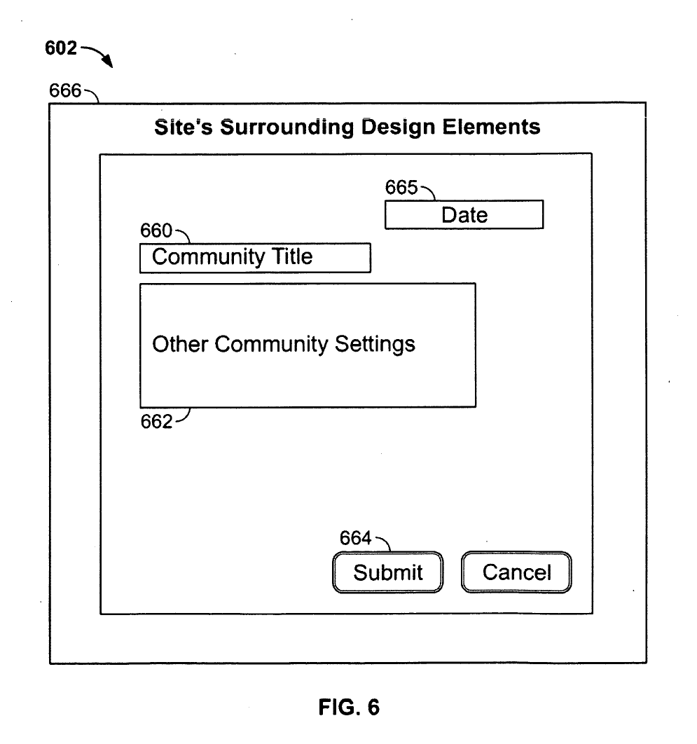

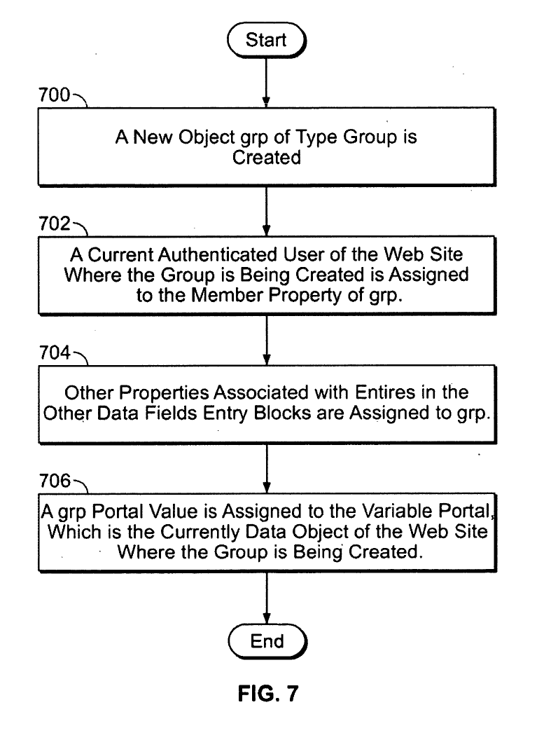

FIG. 6 is a block diagram illustrating a screen in a user's web site for creating a new group. The screen 602 includes an entry field 660 for naming a group associated with a community. Entry block 662 allows a user to set other data fields that may be relevant to the group to be created. Submit/cancel buttons 664 initiate the execution/cancellation, respectively of the group. An optional date field 665 may be shown. The screen 602 shows the web site's surrounding design elements 666, and the underlying method makes note of and stores a portal ID associated with the web site in the database to be described hereinbelow in connection with FIG. 7.

FIG. 7 is a process flow diagram illustrating exemplary steps for creating a new group. At Step 700, a new object grp of type Group is created. At step 702, a current authenticated user of the web site where the group is being created is assigned to the Member property of grp. At step 704, other properties associated with entires in the other data fields entry block 662 of FIG. 6, such as group description and group name from the web site are assigned to grp. At step 706, a grp potal value is assigned to the variable portal, which is the currently data object of the web site where the group is being created.

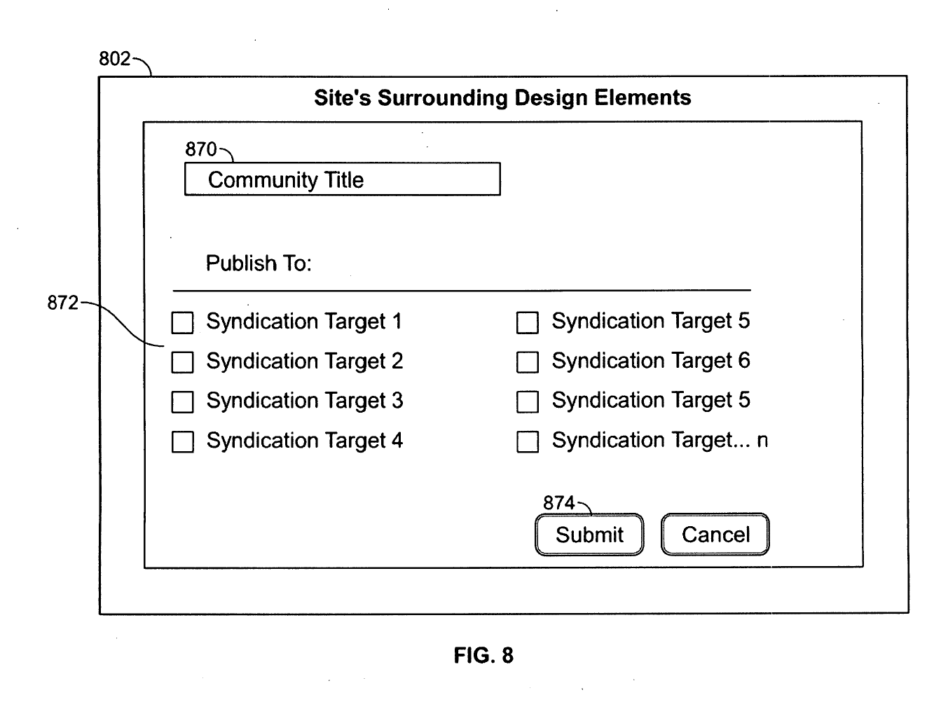

FIG. 8 is a block diagram illustrating a screen in a users web site for publishing a new group. The screen 802 includes a field 860 for displaying the current group associated with a community. Check boxes 872 allow a user to select the available groups (e.g., “Syndicated Target 1”) to be published. Submit/cancel buttons 874 initiate the execution/cancellation, respectively, for publishing the selected group(s). The screen 802 shows the web site's surrounding design elements.

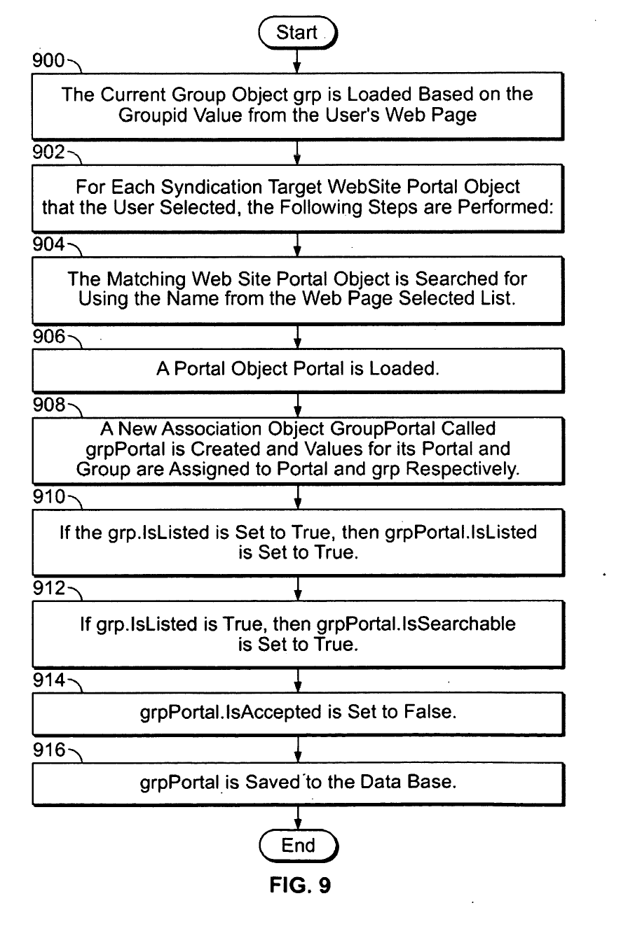

FIG. 9 is a process flow diagram illustrating exemplary steps for publishing the groups selected in FIG. 8. Assuming that a Group Object grp has been created, grp is associated with one or more target web site portals (and stored in one or more syndicated target web site portal objects) selected using the check boxes 872 selected by the user from the web page depicted in FIG. 8. At step 900, the current Group Object grp is loaded based on the groupid value from the user's web page depicted in FIG. 8. At step 902, for each syndication target web site portal object that the user selected, the following steps are performed: At step 904, the matching web site Portal object is searched for using the name from the web page selected list. At step 906, a Portal Object portal is loaded. At step 908, a new association object GroupPortal called grpPortal is created and values for its Portal and Group are assigned to portal and grp respectively. At step 910, if the grp.IsListed is set to true, then grpPortal.IsListed is set to true. At step 912, if grp.IsListed is true, then grpPortal.IsSearchable is set to true. At step 914, grpPortal.IsAccepted is set to false. At step 916, the grpPortal is saved to the database.

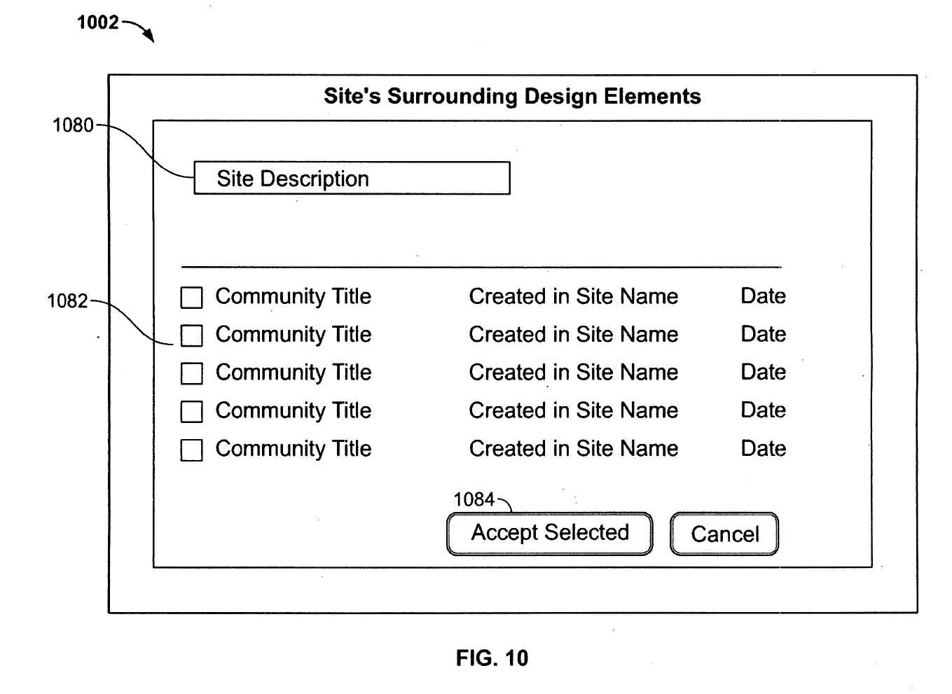

FIG. 10 is a block diagram illustrating a screen in a user's web site for accepting groups published by other web site portals to be available on the user's web site. The screen 1002 includes a field 1080 for displaying the current user's web site description. Check boxes 1082 allow the user to select the available groups to be accepted, which include fields for the community (group) title, the web site the group was created in, and the date the group was published. Accept/cancel buttons 1084 initiate the execution/cancellation, respectively, for accepting the selected group(s). The screen 1002 shows the web site's surrounding design elements.

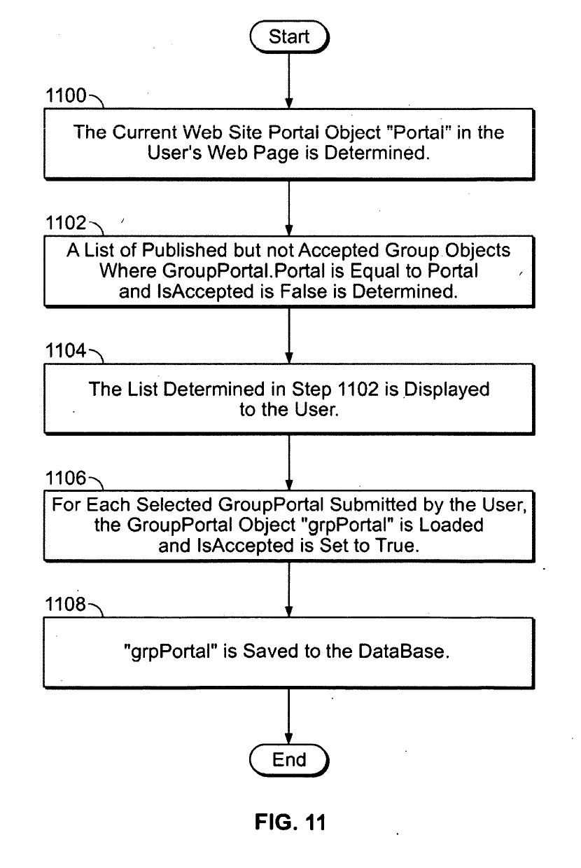

FIG. 11 is a process flow diagram illustrating exemplary steps for a target web site portal to “accept” published groups as depicted in FIG. 10. At step 1100, the current web site Portal Object “portal” in the user's Web Page is determined. At step 1102, a list of published but not accepted Group Objects where GroupPortal.Portal is equal to portal and is Accepted is False is determined. At step 1104, the list determined in step 1102 is displayed to the user. The user indicates with a checkbox click which published group should be accepted to the current web site portal. At step 1106, for each selected GroupPortal submitted by the user, the GroupPortal Object “grpPortal” is loaded and IsAccepted is set to true. At step 1108 “grpPortal” is saved to the database.

FIG. 12 depicts an exemplary block diagram of a news feed screen presented to the user after the user selects one of the links 136, 139, 138 in FIG. 1. The news feed screen 1202 includes areas for group content 1204, 1026, as well as an area 1208 for the news feed itself. The area 1208 displays syndicated content.

FIG. 13 is an exemplary process flow for presenting a news feed to a user, according to an embodiment of the present invention. At step 1302, the current web site Portal Object as portal is determined in Web Page called portal. At step 1304, a list of published and accepted Group Objects where GroupPortal.Portal is equal to portal and is Accepted is true are determined. At step 1306 the list of groups found in step 1304 is restricted to those groups where the current user is a present in the GroupMember list of each group. At step 1308, a union set of messages (and/or reply messages) are gathered from the restricted list of groups where the user is a member (including accepted syndicated groups of step 1304). At step 1310, the list of messages determined from step 1308 is ordered from most recent entry to least recent entry. At step 1312, the list of messages is presented to the user, typically including the date posted, message subject title, short summary of the message, the name of group where the message was posted and the user who created the post or reply. The presentation of the news feed list also includes web hyperlinks that allow the current user to navigate to a particular message, reply, group or user.

FIG. 14 is a block diagram of a syndicated group content module that is presented when a user clicks on one of the groups 136, 138, 139 of FIG. 1. The user display 1402 includes a field 1430 for displaying a community's (group) title, a group description field 1432, a field for posted messages 1434 as well as replies to posts 1436.

FIG. 15 is an exemplary process flow for presenting syndicated user content, according to an embodiment of the present invention. At step 1502, a current web site Portal Object as portal in Web Page called portal is determined. At step 1504, a list of published and accepted Group Objects where GroupPortal.Portal is equal to portal and is Accepted is true is found. At step 1506, a user selects a single group object from the list of groups created in Step 1504. At step 1508, using the group object selected in Step 1506, a list of messages and replies with that group's message list is gathered. At step 1510, the message list is sorted in order from most recent to least recent. At step 1512, a configurable but fixed value (typically 5) is chosen and this number of messages selected at random from the list created is chosen. At step 1514, the group title and short description elements as depicted in 1430 and 1432 are displayed. At step 1516, the list of messages are presented to the user, typically including the date posted, message subject title, shorted summary of the message, the name of group where the message was posted and the user who created the post or reply as shown in fields 1434 and 1436 of FIG. 14.

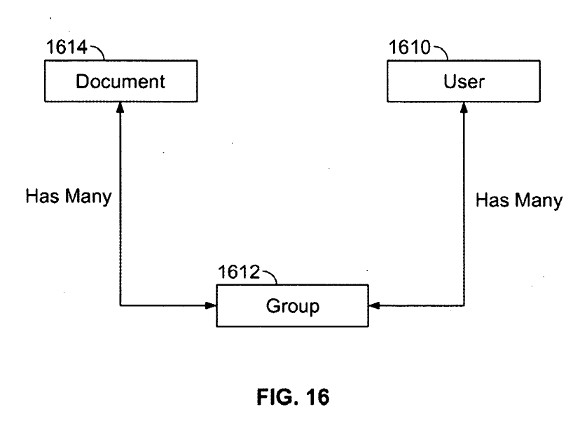

Exemplary embodiments of “Syndicated Communities” are themselves incorporated into a larger product manufactured and supported by Ripple6, Inc. of New York, N.Y., called “Ripple.” Ripple provides a method for sending and receiving documents between groups over a distributed computer network, wherein documents may be propagated across public/private groups. FIG. 16 is a block diagram showing the entities involved in the propagation of documents across groups, herein referred to as a “ripple.” A ripple involves users 1610, each of which is associated with a user name, one or more group names, and an email address. The users 1610 belong to one or more groups 1612. Typically the users 1610 belonging to a group 1612 which has some real-world relationship that establishes a level of trust between members of the group 1612 (e.g., a family group, friends or a club). A document 1614 can be text, such as an email-like message, a file, or formatted attachment. In addition to basic documents, such as email-like messages, in some embodiments, rippling can also be applied to other types of documents 1614 such as Calendar Events, Trading Message items, digital photograph, digital video, digital audio, etc.

Other users 1610 outside the group 1612 initially do not have access to the documents 1614. The embodiments of the invention allow a user 1610 to mark one or more documents 1614 such that other users 1610 in the same group 1612 may or may not share the one or more documents 1614 with members of other groups 1612 to which the users 1610 belong. Members of groups 1612 to which one or more messages 1614 have been sent can in turn propagate these same documents 1614 to groups 1612 to which these users 1610 belong, and so on. As described above, the propagation of documents 1614 across groups 1612 is referred to as a “ripple.” Similarly, the act of propagating documents 1614 to other groups 1612 is referred to herein as “rippling,” and a document 1614 may or may not be “ripple-able” (i.e., send-able). The groups 1612 are similar to bulletin boards, except that messages can be shared across the groups 1612.

If a document 1614 is not marked as “ripple-able,” then only the originating user 1610 may share the document 1614 with his or her own group 1612. Because individual users 1610 make a “ripple-able/not ripple-able” decision on a group-by-group basis, the users 1610 rely not on rights assigned by a group moderator (not shown) of a computer system (not shown), but on real-world relationships between the members of the group 1612.

With Ripple, the users 1610 can create documents 1614 to link a document 1614 to other groups 1612 so that these other groups 1612 can view the document 1614 without losing a connection to the document 1614; edit the original document 1614 and have the changes to the document 1614 be reflected in all copies of the document 1614 throughout all of the groups 1612; delete the original document 1614 and have all copies of the document 1614 be deleted, allow or prohibit other users 1610 to continue to ripple the document 1614; allow the original user 1610 to know exactly how many groups 1612 and users 1610 have access to a document 1614; generate useful analytical data from rippling that can have great commercial value; and, allow the original user 1610 to select useful documents that the user 1610 finds in her groups 1612 and ripple them to a master group where all useful documents are kept.

The author (user 1610) of a document 1614 may always ripple a document 1614. The author 1610 may determine whether the document 1614 may be rippled by other users of a group for which the content was created.

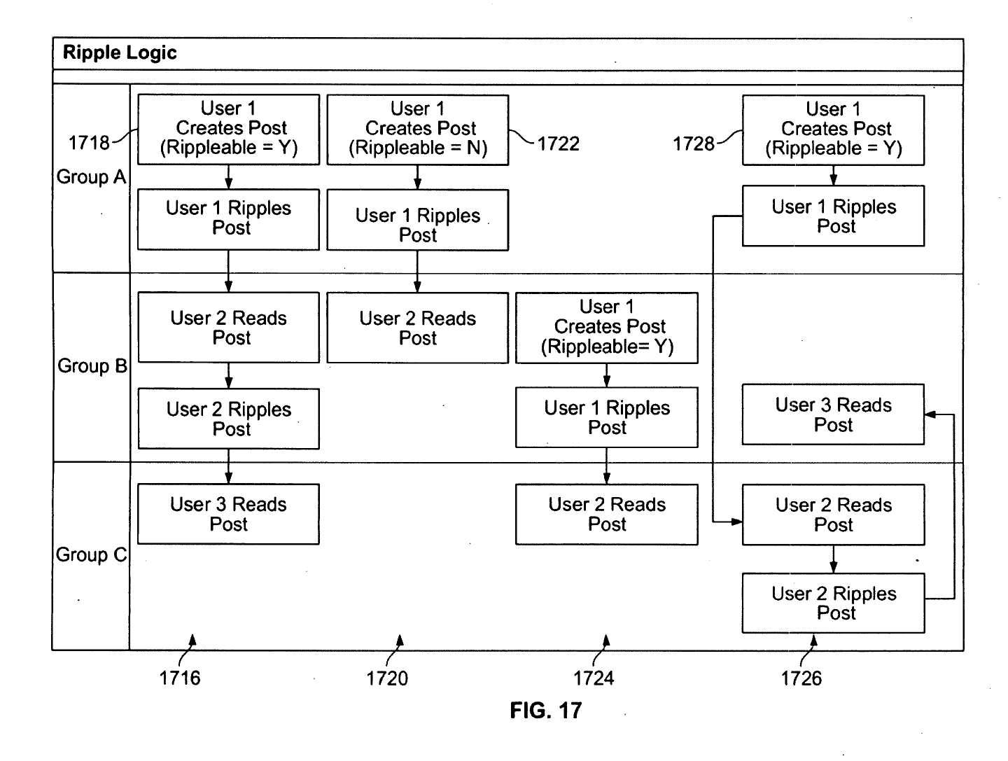

FIG. 17 is a block diagram showing several “Rippling” scenarios, according to an embodiment of the present invention. There are three groups: Group A, Group B, and Group C. User 1 belongs to Group A; User 2 belongs to Group B, and User 3 belongs to Group C. In a scenario 1716, User 1 creates a document (post) 1718. A variable called “ripple-able”, which determines whether the post 1718 may be rippled to other groups, is set to Y (for yes). The post 1718 is sent to Group B, where User 2 reads the content of the post 1718 once User 2 logs into Group B or refreshes her web page. Since the post 1718 is ripple-able, User 2 may ripple the post 1718 to Group C, where User 3 reads the post 1718. In the scenario 1720, User 1 creates a post 1722, but sets the Ripple-able variable to N (for No). The post 1722 is sent to Group B, where User 2 reads the post 1722. Since the post 1722 is not ripple-able, only members of Group B may read the post 1722. The scenario 1724 is similar to the scenario 1716, except that User 1 is also a member of Group B, and User 2 is also a member of Group C. The scenario 1726 is similar to the scenario 1718, except User 2 belongs to Group 3 and User 3 belongs to Group 2. User 1 ripples a ripple-able post 1728 and sends the post 1728 to Group 3, wherein User 3 reads the post 1728, and then ripples the post 1728 to Group B, wherein User 3 reads the post 1728. By default, if the maximum number of degrees of separation is not set, then a post (document) can be infinitely ripple-able. This is the case for the scenarios 1718, 1720, 1724, and 1728. Note that a change or deletion made to any of the posts 1718, 1722, and 1728 by User 1 are reflected in the posts read by User 1 and User 3 once User 1 or User 3 refreshes their web page or logs into a group. Note also, for example, in scenario 1718, that if User 3 creates a response to the post 1718, the response is “rippled” back through Group B and then Group A so that User 1 may review the response.

When a new group is created, the creating user is the first member (user) of the group and may invite any number of other users to join that group by sending “invitations” to other users. These other users, once they become members of a group can in turn invite additional members. The implementation of the creation of a group and how a member of a group invites others to join is discussed hereinbelow.

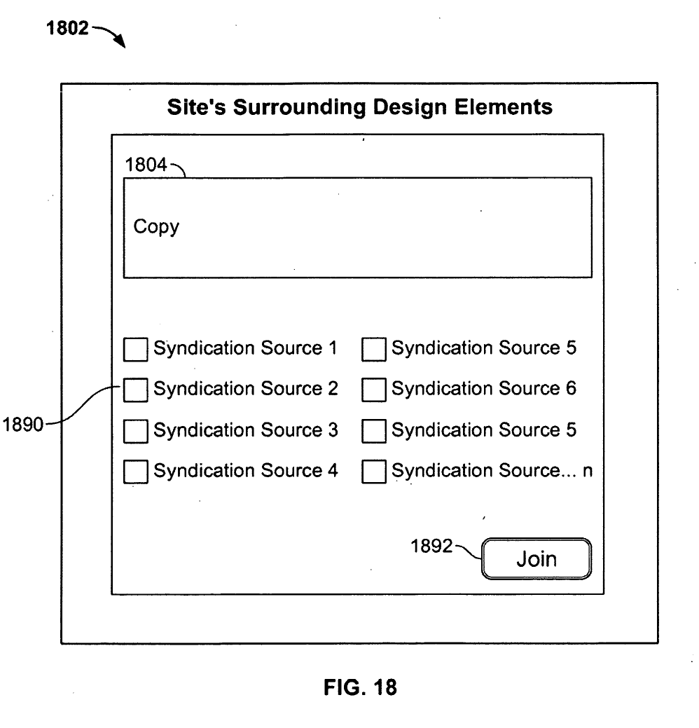

A user becomes a member of a group in one of several ways: (1) visiting and registering at an official web site; (2) creating another group once a member of a group; and (3) being invited by an existing member of a group. FIG. 18 depicts a block diagram of an official web site screen for joining one or more groups. The web site screen 1802 includes a data entry block 1804, a check list 1890 of syndicated groups the user may want to join, and a join button 1892. When visiting the web-site screen 1802, the prospective member indicates that she wants to join a web-site associated and is presented with a typical new user registration form as is known in the art. The prospective member is prompted for a user name, password, email address, etc. After filing out the registration form, the new user is given a home group. For example, if the user name were Malcolm, the group created would be called “MalcolmsFriends.” Initially, the user is only member of the “MalcolmsFriends” group and is, of course, invited to his own group. The new group is assigned a Web Address such as http://www.ripple6.com/group/MalcolmsFriends. For joining a syndicated group, the user checks one or more of the “syndicated Source x” check button 1890.

For creating another group once a member of the first group, a button is provided on several web pages for creating a group. After clicking on the “create a group” button, the user is taken to another web page with a number of fields. The user is asked for the name of the group to be created. The user then fills in a description of the group for people who might join the group, such as what is the purpose of the group. Then the user is presented with another web page for inviting other users to the group. The page has an input box for entering email addresses of people the user would like to invite. Then, the user is presented with a sample message that the invitees will be presented with, such as “Malcolm has created a group. He wants to invite you. Here's the information you need to join the group.” The user then clicks the “send invitation button.” After a predetermined amount of time, say 10 minutes, a database is queried for new group invitations, appropriate information is gathered, and a email messages are to each email address in a previously entered list of invitees. The same invitation procedure is followed for new users who visit the official web-site for the first time.

When a new user is invited to a group or a current user creates a new group, the user receives an email with the group web address and a web link embedded in the email message. Anyone the user wishes to invite can receive a forwarded copy of the email and use the link to join the group. When the new user clicks the link, the new user is presented with a user registration page and after registering, the user is added to the GroupMember list for the group and will see the group listed on the user's own group list in the home page of the web site.

In addition, a newcomer or current user can subscribe to public groups in a fashion similar to subscribing to Netnews groups or public bulletin boards, as is known in the art.

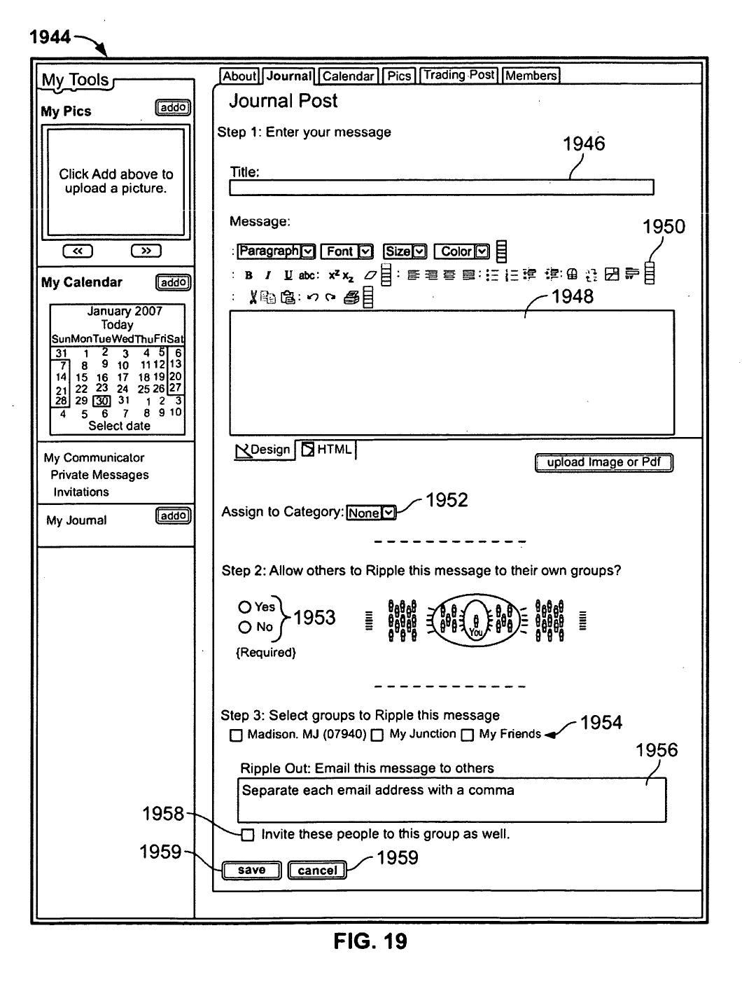

FIG. 19 depicts an embodiment of a user screen 1944 for a user that is originating a message (document). The user screen 1944 includes a title entry box 1946, an entry box 1948 for the message to be sent in “Step 1.” Many formatting operations 1950 can be performed in a fashion similar to Microsoft Word®, such as screen fonts. In the pull down menu 1952, the user can make an assignment to a category which would group messages together for an alternative view of related messages. In the portion of the user screen 1944 labeled “Step 2”, two radio buttons 1953 are presented to the user for allowing the user to decide whether the message just composed can be rippled by others to members of their respective groups, which may not be one of the groups the current user belongs to. In the portion of the screen labeled “Step 3”, the user selects which groups 1954 to which this message is to be rippled (sent). A separate box 1956 allows other users at the entered email addresses to receive this message. Another check box 1958 invites the users entered in box 1956 to become members of the current group to which the user sending the message belongs. Finally, the user sends the message by clicking the “save” button 1959.

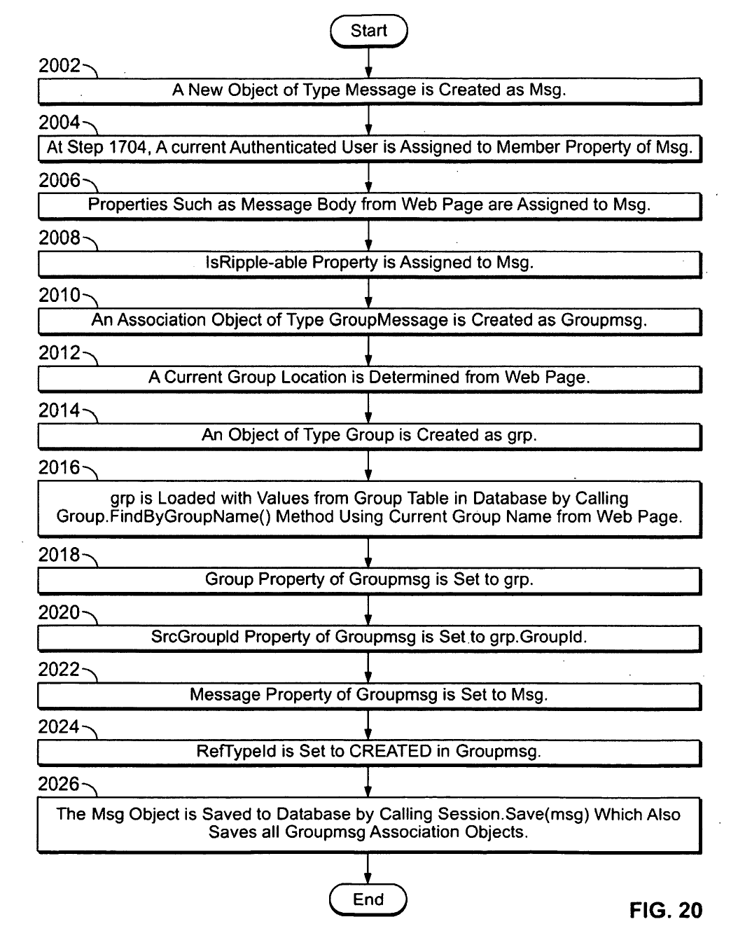

FIG. 20 is a process flow diagram illustrating exemplary steps for ‘Assigning Ripple Properties’ to a new message that a user creates for displaying to his current group or for rippling to other groups to which he belongs. In step 2002, a new object of type Message is created as msg. At step 2004, a current authenticated user is assigned to Member property of msg. At step 2006, properties such as message body from Web Page are assigned to msg. At step 2008, IsRipple-able property is assigned to msg. At step 2010, an association object of type GroupMesssage is created as groupmsg. At step 2012, a current Group location is determined from Web Page. At step 2014, an object of type Group is created as grp. At step 2016, grp is loaded with values from group table in database by calling Group.FindByGroupName( ) method using current group name from Web Page. At step 2018, Group property of groupmsg is set to grp. At step 2020, SrcGroupId property of groupmsg is set to grp.GroupId. At step 2022, Message property of groupmsg is set to msg. At step 2024, RefTypeId is set to CREATED in groupmsg. At step 2026, the msg object is saved to database by calling Session.Save(msg) which also saves all groupmsg association objects.

In summary, to create a new message, a blank message object is created. The current user that created the message is assigned into the member I.D. or the member property of the message. Then the message body, the title, and other fields typical of an email message are assigned to the message object. As shown in FIG. 19, if the user selected that the message is ripple-able, then in step 2010 above, an association is made between the message and a selected group to which to ripple the message, i.e., a groupmsg object, by adding a row to the group message table. In step 2012, for each group to be associated with a message, i.e., a group for which the message is to be rippled (sent), the current group I.D. is saved. Then the groupmsg associations are created for each ripple-able group beginning with the source group of the message. Then the message and each groupmsg association are saved in the database database. Note that there is only one copy of the message (document) stored in the database.

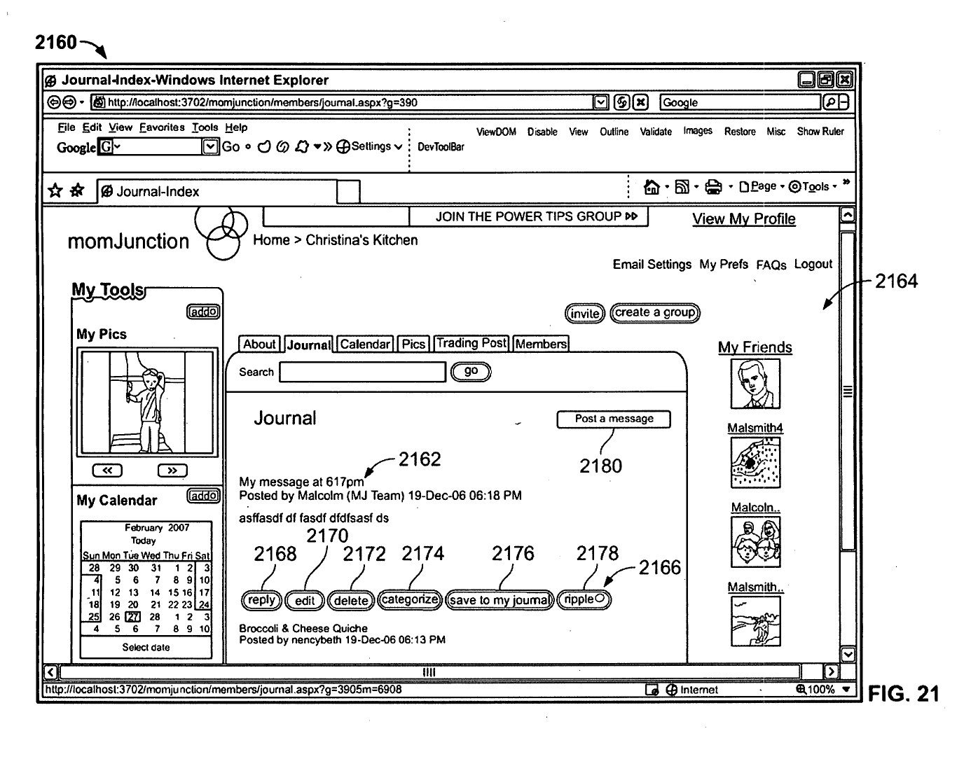

FIG. 21 depicts a user screen 2160 for a user that is receiving a message. Each message 2162 is displayed in its own area of the screen 2164. An array of buttons 2166 allow the receiver to enter a reply 2168, edit the message 2170, delete the message 2172, categorize the message 2174 into a user defined category name like ‘recipes’ or ‘jokes,’ save the message to the user's local journal 2176, or ripple the message 2178. The upper right corner of the screen 2164 is a “post a message” button 2180 for sending a new message.

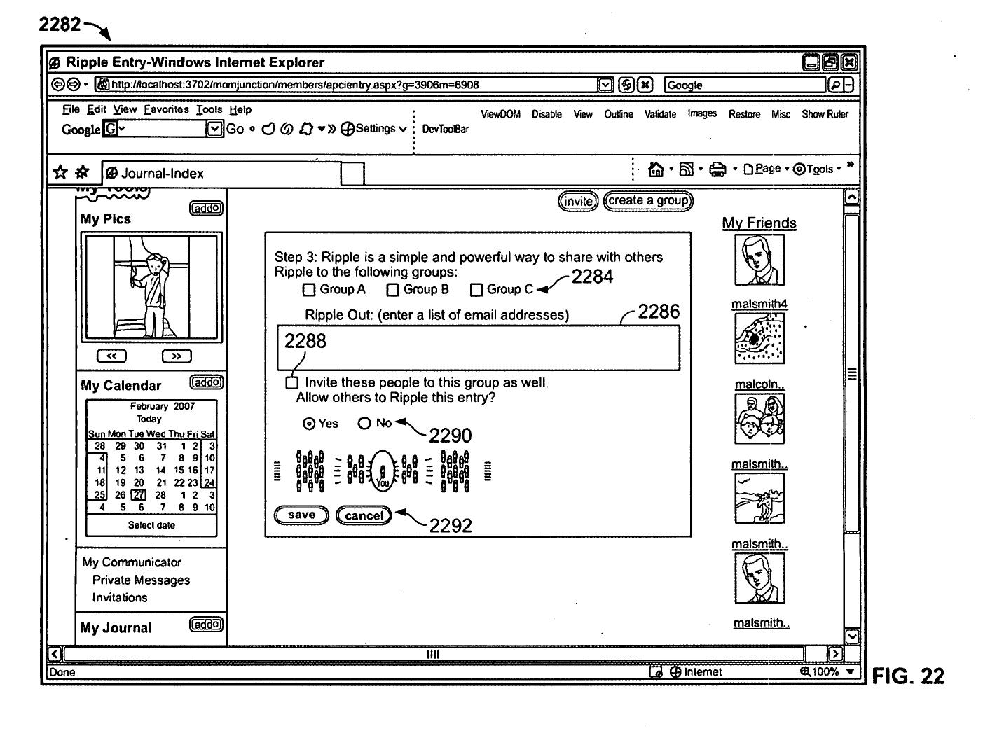

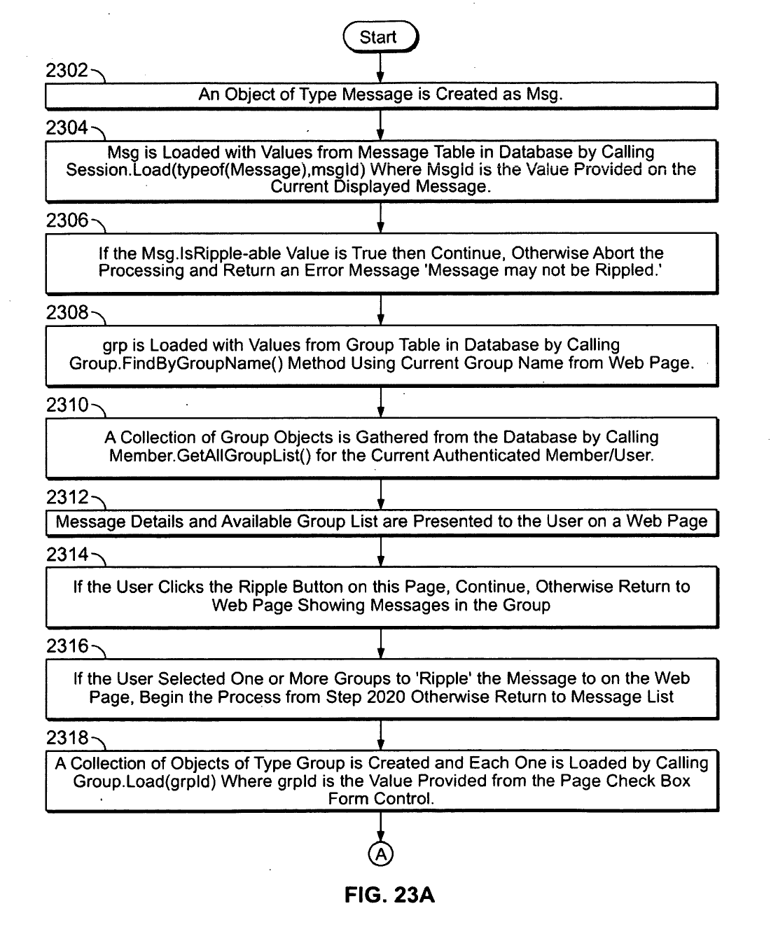

Referring now to FIG. 22, second screen 2282 continues the user screen 2260. In the second screen 2282, the user is presented with check boxes 2284 listing all Groups to which the user belongs. A check in one or more of the boxes 2284 determines the groups to which a received message is sent (rippled). An input box 2286 allows the user to enter other email addresses to which to send the rippled message for receivers not belonging to one of the groups listed in the check boxes 2284. Another check box 2288 invites the users associated with the email addresses listed in the box 2286 to join the current user's group. The radio buttons 2290 allow other users to ripple the received message. Finally buttons 2292 allow the user to save or cancel the current set of choices, which itself may result in a ripple of the just received message.

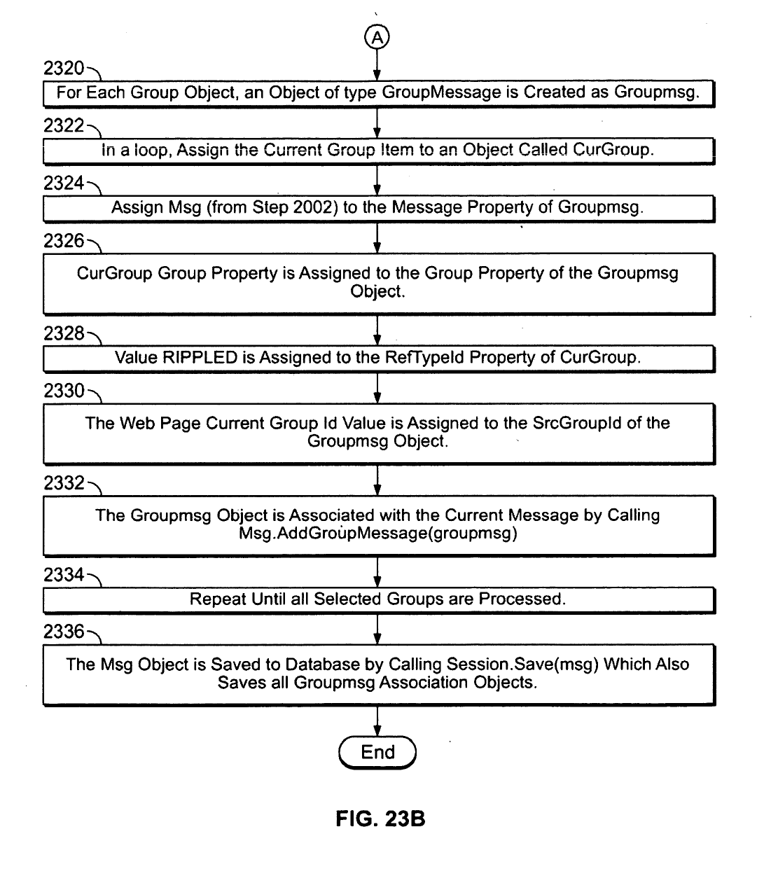

FIG. 23 is a process flow diagram illustrating exemplary steps for rippling a message to other groups. This exemplary method is executed when the user has clicked the ripple button on a web page that lists messages received in a group in either FIG. 19 or FIG. 21. In the method described below, it is assumed that the user is a member of three other groups (Group A, Group B, Group C): At step 2302, an object of type Message is created as msg. At step 2304, msg is loaded with values from message table in database by calling Session.Load(typeof(Message), msgId) where msgId is the value provided on the current displayed message. At step 2306, if the msg.IsRipple-able value is true then continue, otherwise abort the processing and return an error message ‘message may not be rippled.’ At step 2308, grp is loaded with values from group table in database by calling Group.FindByGroupName( ) method using current group name from Web Page. At step 2310, a collection of Group objects is gathered from the database by calling Member.GetAllGroupList( ) for the current authenticated Member/User. At step 2312, message details and available group list are presented to the user on a web page (see FIG. 21). At step 2314, If the use clicks the Ripple button on this page, continue, otherwise return to web page showing messages in the group (see FIG. 21). At step 2316, if the user selected one or more groups to ‘ripple’ the message to on the web page, begin the process from step 2318 otherwise return to message list (see FIG. 21). At step 2318, a collection of objects of type Group is created and each one is loaded by calling Group.Load(grpId) where grpId is the value provided from the page Check box form control. At step 2320, for each group object, an object of type GroupMessage is created as groupmsg. At step 2322, in a loop, assign the current group item to an object called curgroup. At step 2324, Assign msg (from step 2302) to the Message property of groupmsg. At step 2326, curgroup Group property is assigned to the Group property of the groupmsg object. At step 2328, value RIPPLED is assigned to the RefTypeId property of curGroup. At step 2330, the Web Page current Group Id value is assigned to the SrcGroupId of the groupmsg object. At step 2332, the groupmsg object is associated with the current Message by calling msg.AddGroupMessage(groupmsg) At step 2334, repeat until all selected groups are processed. At step 2336, the msg object is saved to database by calling Session.Save(msg) which also saves all groupmsg association objects.

In summary, to ripple a new message, a blank message object is created. As shown in FIG. 19, if the user selected that the message is ripple-able, then in steps 2308 and 2310 above, the available groups for that user are displayed. If the user clicks the ripple button, then an association is made between the message and a selected group to which to ripple the message, i.e., a groupmsg object, by adding a row to the group message table. For each group to be associated with a message, i.e., a group for which the message is to be rippled, the current group I.D. is saved. Then the groupmsg associations are created for each ripplable group beginning with the source group of the message. Then the message and each groupmsg association is saved in the database. Note that there is only one copy of the message stored in the database.

The groups that received the rippled content see the new entry in their group. The new entry is directly connected to the original entry so that if the author edits or deletes the entry, all the rippled entries will see the edits. “Seeing” a new entry, edited entry, or deleted entry in a group is effected when a user refreshes his web browser screen or logs into a group session.

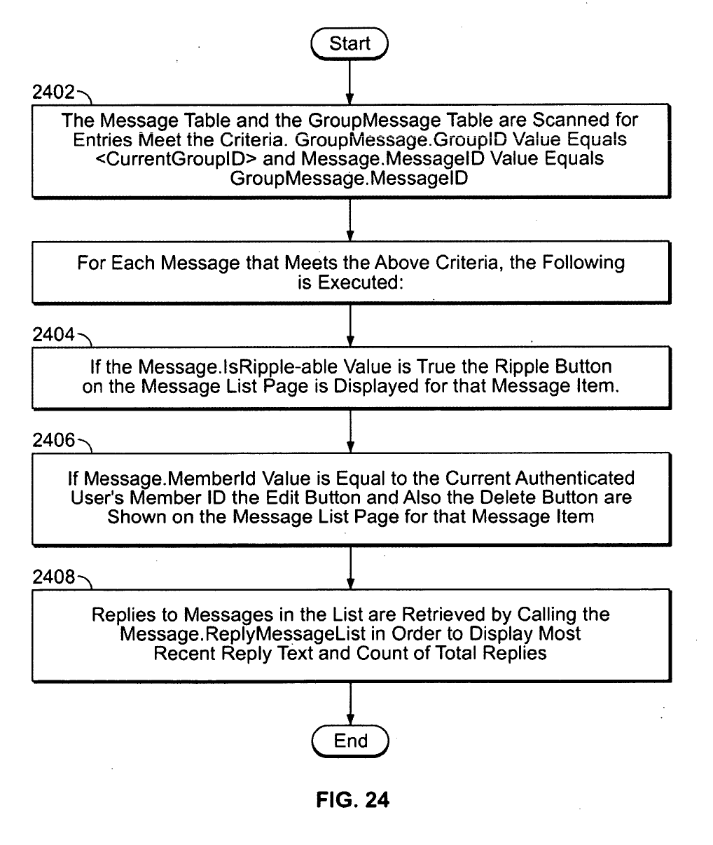

FIG. 24 is a process flow diagram illustrating exemplary steps for ‘Seeing’ or ‘Displaying Messages in a Group’, which include messages belonging to or rippled to a group as well as ‘seeing’ responses to previously posted messages. It is assumed that a user has selected a particular group name from a list of groups that the user belongs too. The user is presented with a list of messages in the group according to the rules of the process flow of FIG. 24. Messages are selected according to the following criteria: (See Tables 1-7). <CurrentGroupId> below refers to the primary key value of the Group table corresponding to the group the user selected in the web site's group list page. At step 2402, the Message table and the GroupMessage table are scanned for entries meet the criteria. GroupMessage.GroupId value equals <CurrentGroupId> and Message.MessageId value equals GroupMessage.MessageId. For each message that meets the above criteria, the following is executed: at step 2404, if the Message.Is Ripple-able value is true the Ripple button on the message list page is displayed for that message item. At step 2406, if Message.MemberId value is equal to the current authenticated user's member id the Edit button and also the Delete button are shown on the message list page for that message item. At step 2408, replies to messages in the list are retrieved by calling the Message.ReplyMessageList in order to display most recent reply text and count of total replies.

When a user has logged in or presses the refresh button, a message is sent to the database to retrieve all messages for that user in the users group. For each message in the message table in the database, if the group message group I.D. value equals current group I.D. and message I.D. value equals group message, then that message is retrieved and displayed to the user. For each message matching the above criteria, the ripple-able property is checked. If ripple-able is set to true, then the ripple-able button will be displayed for that message. If the message member I.D. is equal to the user's member ID, then the user is presented with the options of editing or deleting the message to be displayed along with the message itself. Any replies to that message are also retrieved and displayed to the user. A list of any replies to that message is retrieved and displayed to the user.

FIG. 25 is a process flow diagram illustrating exemplary steps for modifying the IsRipple-able property on an existing message. It is assumed that the user has clicked the edit button on a web page listing messages in the users group (See FIG. 21). Note that the Edit button is not visible to a user that is not the original creator of the message object. At step 2502, an object of type Message is loaded as msg by calling Session.Load(currentmessageId) using the messageId from the message list. At step 2504, it is confirmed whether the MemberId of msg is equal to the current user's MemberId. If the values are not equal, then at step 2506, page loading is aborted and execution returns to the message list. At step 2508, the values of the message object are displayed in the Edit message web page user interface. At step 2510, the user is allowed to update any values on the web page. At step 2512, if the user Clicks the Save/Submit button, then object values are saved to the database by calling Session.Save(msg).

In summary, a message object corresponding to the message to be edited is loaded into the user's web page from the database, assuming the current user is the creator of that message. The user then changes the message. The message is then saved back to the same row in the database. Saving the message means that there is only one copy of the message in the database. Note that if the user changes the value of the IsRipple-able property, there is no immediate effect on the message or its related data elements in the database. The only effect of a change to IsRipple-able=TRUE is that the message list of any web page of any group containing the message would now include a Ripple button next to the message item. Setting the value of IsRipple-able to FALSE would display the message without a Ripple button. The presence of a Ripple button on a user screen (and subsequent data validation) is the only way a user can initiate a Ripple operation. Note that a change of the value of IsRipple-able for a message does not modify the GroupMessage associations that already exist in the database.

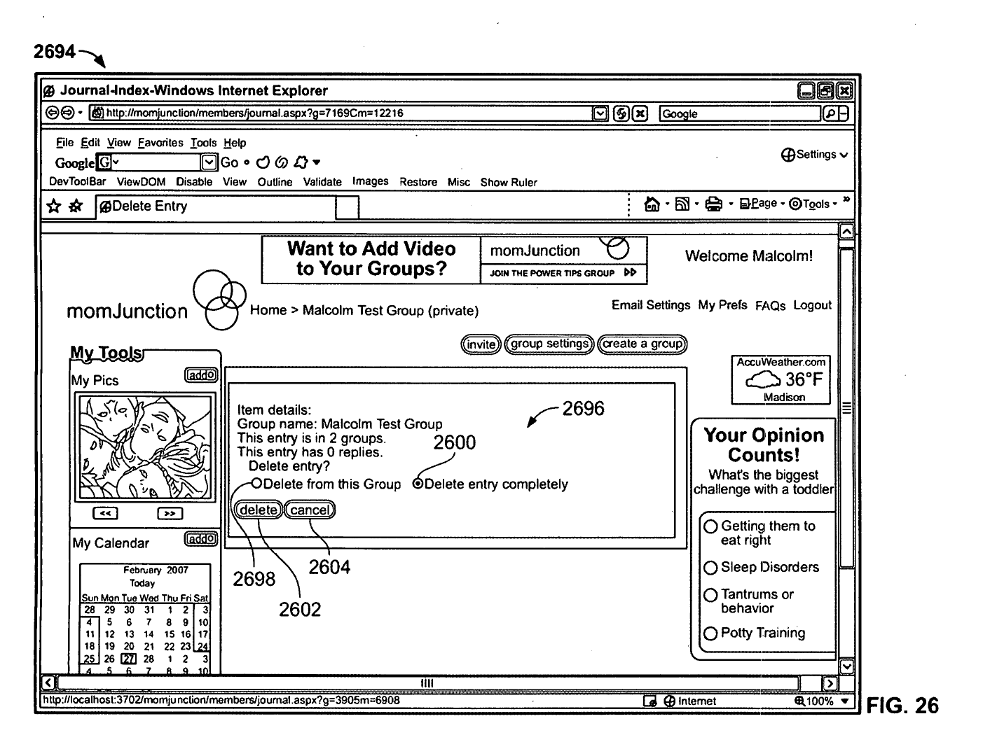

FIG. 26 depicts a user screen 2694 for a user that is deleting a message. The user is presented with a list of message details 2696, including the group name, the number of groups the current message appears in, and a count of the number of replies to the current message. The user is then presented with a check button 2698 for deleting the message from the current croup, and a check button for 2600 for deleting the message from all groups. The user this then prompted with a delete the message button 2602 or cancel the deletion button 2604.

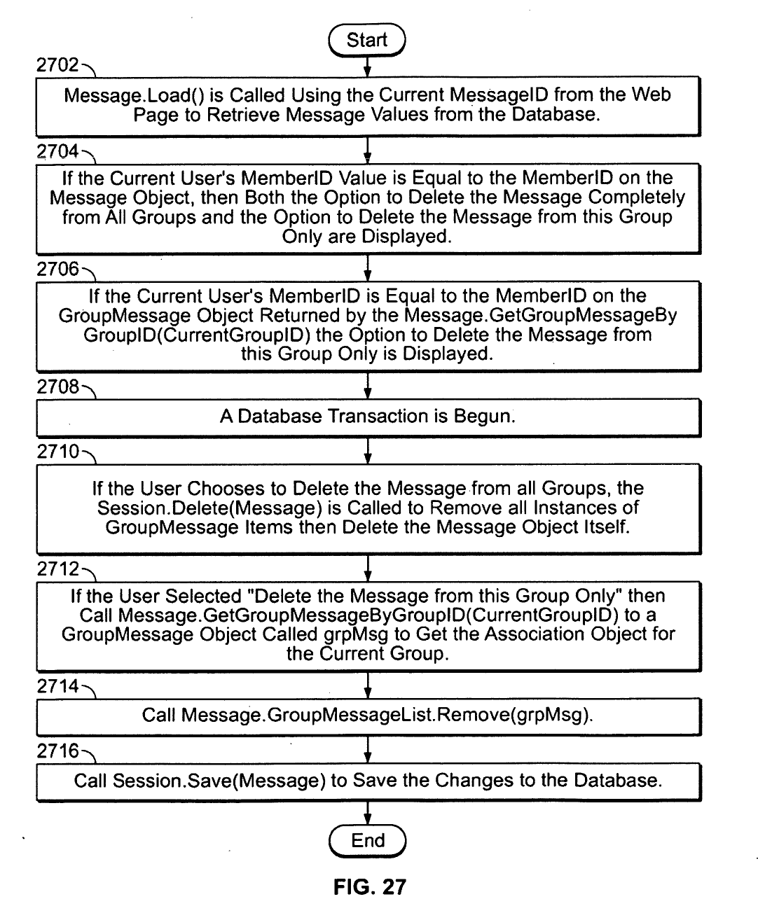

FIG. 27 is a process flow diagram illustrating exemplary steps for deleting a messages in a group. It is assumed that the user has selected a particular message from the message list in a group. At step 2702, Message.Load( ) is called using the current messageId from the web page to retrieve message values from the database. At step 2704, if the current user's memberId value, is equal to the MemberId on the message object, then both the option to delete the message completely from all groups and the option to delete the message from this group only are displayed. At step 2706, if the current user's memberId is equal to the MemberId on the GroupMessage object returned by the Message.GetGroupMessageByGroupId(currentGroupId) the option to delete the message from this group only is displayed. At step 2708, a database transaction is begun. At step 2710, if the user chooses to delete the message from all Groups, the Session.Delete(Message) is called to remove all instances of GroupMessage items then delete the message object itself. At step 2712, if the user selected “delete the message from this group only” then call Message.GetGroupMessageByGroupId(currentGroupId) to a GroupMessage Object called grpMsg to get the association object for the current group. At step 2714, call Message.GroupMessageList.Remove(grpMsg). At step 2716, call Session.Save(message) to save the changes to the database.

In summary, if the user memberID matches the messages memberID, then that user is the owner of the document. In such circumstances, the user has the option to both delete the message from the current group or from all groups. If the users memberID matches only the current groups memberID (i.e., the user is not the owner of the message), then that user can delete the message only from the current group. If the user is the owner, then both all group message associations and the message row itself is deleted in the database. If the user is not the owner, then only the current group message association is deleted in the database.

FIG. 28 is a block diagram of an exemplary system 2830 for syndicating a group and/or rippling documents over a distributed network, according to an embodiment of the present invention. A plurality of users communicate via a corresponding plurality of terminals 2832. The terminals 2832 can be personal computers, work stations, PDA, smart phones, etc. The terminals 2832 are capable of reading a program from memory which presents a plurality of user screens within a web browser, such as Microsoft Internet Explorer. The user screens include areas for reading documents of members of a group to which a user belongs, areas for composing documents (post, message, email) that are to be rippled or groups syndicated, and buttons and input boxes for collecting user information, such as selecting a group to syndicate. Client software for syndication at each web site resides in the terminal 2832. Messages containing syndicated blog information and rippled documents are associated with source and destination addresses and sent in TCP/IP packets via the Internet 2834 through a firewall 2836 and an IP router 2838 to one or more web servers 2840. A message is any information shared between the terminals 2832 and the web servers 2840, or between servers. A message can comprise a document. In other embodiments, the terminals can communicate with any type of server over any distributed network, including private intranets, local area networks (LANs), wide area networks (WANs), etc. The web-servers 2840 have one or more processors, volatile RAM memory, and non volatile memory, such as hard or optical disks and flash memory (all not shown). The one or more processors of the web-servers 2840 are capable of reading and executing from memory a server ripple program described above. The server ripple program is capable of functioning as a main web-site for the ripple service. The web-servers 2840 send and retrieve data concerning users, groups, and documents to/from a database server 2839 and to/from the web browser programs resident on the plurality of terminals 2832. The database server 2839 also communicate with a notification server 2842. On a periodic basis (including every few minutes, once a day, once a week) the notification server 2842 queries the database server 2839 to generate a variety of email messages to send to users who request such updates in order to report new activity or changes on the web site associated with the web-servers 2840.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A method for syndicating a group from a first web site to one or more additional web sites over a distributed network, comprising the steps of:
creating a group at the first web site;
publishing the group to make the group available for syndication;
presenting the group as potentially acceptable for syndication at a second web site,
receiving a selection that the group is acceptable;
associating the group with the second web site in a database;
making a request to the database by the second web site to determine if there is any acceptable group content to be rendered on the second web site;
transmitting the acceptable content associated with the group to the second web site; and
rendering the acceptable content at the second web site.

2. The method of claim 1, further comprising the step of syndicating the group to a third web site, wherein the acceptable content is visible in the first, second, and third web sites.

3. The method of claim 1, further comprising the step of sending a message to the group, wherein the message is readable in the first, second, and third web sites.

4. The method of claim 3, further comprising the step of sending a reply to the group, wherein the reply is readable in the first, second, and third web sites.

5. The method of claim 1, wherein the first web site and the second web site view identical news feeds.

6. The method of claim 1, wherein the acceptable content is at least one of a blog, news, shared community information, a discussion forum, and a micro site.

7. The method of claim 1, further comprising the step of setting permissions of the group to allow syndication to other web sites.

8. The method of claim 1, wherein the group is one of a private group and a public group.

9. The method of claim 8, wherein the group is a private group, and a first user is permitted to join the group via an invitation from a second user of the group.

10. The method of claim 9, wherein the invitation is in the form of an email with a link to a registration page.

11. The method of claim 1, further comprising the steps of:
receiving a first message from a member of the group comprising a document, the first message also comprising an indication of whether the document is send-able to other groups to which the first member belongs;
sending a list of groups to the member of the group to which the member belongs if the indication indicates that the document is send-able to other groups;
receiving a message which indicates that the document is to be sent to a second group,
associating the document with the second group; and
sending the message to the group and the second group.

12. The method of claim 11, wherein the document is viewable in the group and the second group at both the first web site and the second web site.

13. The method of claim 11, wherein the document is one of a text message, a file, and a formatted attachment.

14. The method of claim 11, wherein the document is one of an email-like message, a calendar event, a trading message item, a digital photograph, a digital video attachment, and a digital audio attachment.

15. An apparatus for syndicating a group from a first web site to a second web site over a distributed network, comprising of:
a web-server:
for receiving an indication that a group has been created at the first web site;
for publishing the group to make the group available for syndication;
for presenting the group as potentially acceptable for syndication at the second web site;
for receiving a selection that the group is acceptable;
making a request to determine if there is any acceptable group content to be rendered on the second web site;
transmitting the acceptable content associated with the group to the second web site; and
rendering the acceptable content at the second web site; and
a database server for associating the group with the second web site in a database.

16. The apparatus of claim 15, wherein the web-server is further configured:
for receiving a first message from a member of the group containing a document, said first message also containing an indication of whether the document is send-able to other groups;
for sending a list of groups to the member of the group to which the first member belongs if the indication indicates that the document is send-able to other groups;
for receiving a message which indicates that the document is to be sent to a second group;
for associating the document with the second group; and
for sending the message to the group and the second group.

17. The apparatus of claim 16, wherein the database server is further configured:
for storing an association of the document with the second group;
for storing an association of the second group with the document in the database; and
for storing the document in a database.

18. The apparatus for of claim 17, wherein the distributed network is the Internet and further comprising:
an IP router for routing messages between the Internet and the web-server;
a firewall for protecting said web-server from unwanted messages; and
a notification server for querying the database server on a periodic basis to generate messages to send to users in order to report new activity or changes on the web site associated with the web-servers.

19. The apparatus of claim 18, wherein said notification server queries the database for a list of new group invitations and sends email messages to each email address in the list.

20. A computer-readable medium storing computer code for syndicating a group from a first web site to one or more additional web sites over a distributed network, the method being executed by at least one processor, wherein the computer code comprises:
code for creating a group at the first web site;
code for publishing the group to make the group available for syndication;
code for presenting the group as potentially acceptable for syndication at a second web site;
code for receiving a selection that the group is acceptable;
code for associating the group with the second web site in a database;
code for making a request to the database by the second web site to determine if there is any acceptable group content to be rendered on the second web site;
code for transmitting the acceptable content associated with the group to the second web site; and
code for rendering the acceptable content at the second web site.
